SEQUENCE LISTING (252 sequences)

SEQ ID NO: 1 - DNA, 242 bp, Homo sapiens
cacagggctcgggcgacttcagcgaggctctgtctgagagtctctgccccggaggccgaagaacggagtccacggcagggagccaaacaccagcgcagcactgtccccagaagtgcccgctgcctccccgagcggagacgtgacctggcttggggccgcacgcagggggaagcgtatccaacaccgcaggcccggcccctccccacgcgcgccagacggtccccaccctgcgcctgtgcatg

SEQ ID NO: 2 - DNA, 191 bp, Homo sapiens
gctcactcaccgttcgctgccgcgggcgcctgcgggggcgtctacatgccggaccgagcccgcaggccccgccgccgcgccgccgccagccgtcgctacctggcccttggcgccctggccgcctgttgccccatggccgcccggaccccggcgccggcgccgccgagcagcaatgcgccgcgcccgcccac

SEQ ID NO: 3 - DNA, 222 bp, Homo sapiens
ggccggtgttggagcatccgtctctgcgtccccacctgatgacaagctccggggagcaggagtgctggccaagcccacgcacggaccaagcccacgtcagactccgccagaaaggcaagaagggcctccgcatggcgtgacggatgggtttatgggggcattccatcccacccggacgctcggagggcagggagacaggaagatcaggcgaccaaaagtgca

SEQ ID NO: 4 - DNA, 223 bp, Homo sapiens
cgcttgctccggccgatctggcccagcttgggcggccgcttgttctgcccggcgccgaagaagttgttggtgtcctgcaggcggcaggagaagatctggcccacgtcgccgccgtcgccgtaggggctcagcttctcgtcgccgtagggcagcacctccgacatggtcgcgtccgggggctccgccgcggcgcctcctccgcccgcgtccccgcccgcggcgg

SEQ ID NO: 5 - DNA, 259 bp, Homo sapiens
cgtaccactactctaacaaaccagtgcctcgaaagctatttcttgcctccggtacttcccttttaaccatgaagttttcacgctagaggctactcaacgcacacacaggcccgcccagactgtggagcgggacctgtttagagtagaaaccgagtcgccaaagaaaccagtgttggctctttagagggagatttaacttgagcctagaccggttccgaacccctttcccgagccctcctgacgtcatgggaccttccgg

SEQ ID NO: 6 - DNA, 198 bp, Homo sapiens
ggtgaacccgtagcgcctctctcggtaacggcggctgcgggatcgcgaccggctccgcgagtatgaccgcgagtagcgcctgtacttccgctggtggcgccttcgggaacgggacctggacttgctcctccgactcctggacgaaaaccggctcgagacgcgggaatgggaccgagagcttctggaaaaagagcggct

SEQ ID NO: 7 - DNA, 352 bp, Homo sapiens
tcagcgctgacctctcccctccccctccgctgtgtccatcgcagtccgccggccccctcccagcgtctctcgaccccttccccccttccctgtactccagccgcggctgattcctgctgtctgggtggggtccctgtaaggctcaggcggctgactggggaggcgatcccaggaggcacagtggggaggggatagcagggcggaaagaggctgaatcacaaggaggcgggggcggcggctcggtcccagggccatctcagggaccgtgtcggggggtgctgactctgcccatcaaggggagccggacatttatccgccaaagcccgtccctcgcggtgagggtcgctcctgg

SEQ ID NO: 8 - DNA, 237 bp, Homo sapiens
ggagcccgccccctgtggccgggcctcctccaatccccaccgtttcttccgggacggatacctgcctccgccaattgtcgcgtaccctggccaggtaactagggccgagttacaaccgcgcggcgttggcatctccagctccagctctgcgcacctataccgagacagccacaggaattcaggatcccgggtcgcagaatcgaagcctgtgcaggaacaaatgggggcagactgagc

SEQ ID NO: 9 - DNA, 273 bp, Homo sapiens
cttcccctacgctaaaaggacgaacccacaccttccgcgggattccgcccgggcttccaacgtggagacgacttttactgagctggtttaacagttgcccacgaacgcttaagcacgcccagacccactcaagtacaggccaagaagtcggtgggatcggggagggcgggggcttcgggcctgggcggcgcaaaggctccccaggaaggctgcgggggccccccggagctgacggcgcggcgcggcgcggcgctgcgcggccccggactgggc

SEQ ID NO: 10 - DNA, 205 bp, Homo sapiens
ctccttcctggggccgaagaagaaaacctttctgcgctgccaccccggccgggagctggcggtcaagttcgcggtacaaggagctagggacgtcagccctccagcccgcgcctgtatctcggggtggtataaacaggatgtcagacagcgcgctccgggcttgtttatgaaaacttgccgtgcgcgctgggggagggggcggcct

SEQ ID NO: 11 - DNA, 198 bp, Homo sapiens
aagtttgtcctaaccaaatgaatacaagaagagagccttcaaaataaaccggggcgggggggggccgagctgcagcttgcggctcagcccgcaaggcaccctgagggcgcggccagcggggaacgcaaaccgcgtccgtgcacgagtccgggagccacagcctgggccacggcaattgactgcgaacccacaacaaac

SEQ ID NO: 12 - DNA, 217 bp, Homo sapiens
caccccctagcgccgctgggcctgcaggtctctgtcgagcagcggacgccggtctctgttccgcaggatggtgagtggatgcctcggtctcggggctttagatgcatggaggttcccttttcttgcccgtatgccagcctagggcccgtctcgcgcgtcgcaggggccggatggcgttagattgctagctctgacttggtcgaggtgcagttcccag

SEQ ID NO: 13 - DNA, 249 bp, Homo sapiens
atgtgcagtgacatttctgacttgagtggaggaatgcgcgaaggaaacccgggcgaaattggtattagaggatcttcttggcgccaatgctaattgtcctgatttatgccccttctgactaagctcaacgtcttcatctgaaataaaatgaaagcggtgccaagcggcatagaaccgcctggccgctggttctgatccccgggaaccagaaaatcgtcctgcggcttgaaaaaaaaaaaaagaggaaaa

SEQ ID NO: 14 - DNA, 197 bp, Homo sapiens
ccccgcctcagcctttcccgccgctcgggcgctgagcccagggaccagccggcggcagtgaccccgcccgaagccccttctggaacctcctggggacaattcccttttcctttcttcagcctaacccgcggtggccctcgcggagtccggtcagccccggggagcgcagccgggaggggcgtccaaggggcgtctcg

SEQ ID NO: 15 - DNA, 277 bp, Homo sapiens
gtggggtccccactctgcaggggcgcgcccctgccccgcgcgccgactccgggtaccagagccgtcagccccgcccctcgggcagggggcgggcgtggaaacgcctaagaggatgctgagtgacagaggcgcaggccgcgctccgaccctgccatgtctctccccagctgtctctcccgccagccgccgcgtcctcaacgtcctccccttttagcagactgggctcccggagcagcagcggccggccgcgcagacgcaaagcctcggggatggagga

SEQ ID NO: 16 - DNA, 215 bp, Homo sapiens
cagccccagccgggctcgcggcagcgaaagcaaaatccgatctctctcccgggggagcaaaatggacgaaaggcgaccccccaggcaggggcgctgggtgccttgggaatccgaggaatcccttctctttgccagtcggaggggactagatggagccgaaggggccggagatgggccgagcgctgccccccgggggtcctcggcgccgggcgcag

SEQ ID NO: 17 - DNA, 223 bp, Homo sapiens
caccccctcctgcgctgtccatggataagatctcccccagccccgaggccgggaacgatcctgtcctccagtgacctccttttccctccccttacctcctccttaccagagctttaaggtgaaagcacagagcaaccagcagaggtggcggccctgggggaggccaggcctcccggcacccgcaagcatggagcgccaagtgtcgcacctgtcggaacagagg

SEQ ID NO: 18 - DNA, 209 bp, Homo sapiens
gcgccgaatcctaaccactagaccaccagggagaggcggcttcagggcccggcttgcgcctcctggccccagcgcctctggccccagcactgggcgctaccttggcgcctgtcccctgcttcgctttaaaacaaacaccgcaaccagcccccgcgacgccggcggcaaccggcctgccctcacgagcagctctggccctgttcgcagca

SEQ ID NO: 19 - DNA, 214 bp, Homo sapiens
ggcgcaggcgttcgcgccgggtcccagccatgccagcggcgacgcgccccggcgcgccgtcaggatggccgagcggtctaaggcgctgcgttcaggtcgcagtctcccctggaggcgtgggttcgaatcccactcctgacaagccgaccttttggcccgcccgccggagggcaacgcccatggcaaccctggagcacctttggccgcttcctgc

SEQ ID NO: 20 - DNA, 205 bp, Homo sapiens
ggaacgtagcgggcggaaactctcgaaaagcgactgcgcaggcgcgcgccgggcgcggacgctcacgggtcacccagggtatccgccccaagcggagaatatcggcgcaagcgcggagtagccgtgtcacgcatgcgtgcgaacgcaccacattccggaacgggaagaaggagctgtctctctcttctgaggggtaggcaggtgc

SEQ ID NO: 21 - DNA, 216 bp, Homo sapiens
tctcatcgctccgcgggagcccaggaactgccctacaacagccgaaatccgggtcgtctattccaacggactcctcttccgttggatacgggggccgtgagaggccaaacaacctccgcgaggctacccccgcagcgaccgctcggcgggcgctccattcctttaccggactgtacacctcgcctcctggggcctgaggcgggaacccgggtcgcg

SEQ ID NO: 22 - DNA, 218 bp, Homo sapiens
gcgccgggagagtcctgcccctgtggcttgcacgctcagcagggcgccccgggcaccctggagagaccaaggagttcctcgctccgcttgccaaggggttgtacttccgcctgcgacttctttagtggtgcggtagctacatcttcggggtttactttaagtaagggccggctcatccagggatggtgactacctacaaactagggcgcacgagcgcg

SEQ ID NO: 23 - DNA, 254 bp, Homo sapiens
agtgttccgcaaatccttgccgaattccatcccggccaaagcagggacccgggggagcctctggtcgcacccgagacagttcgttaaatactcagtgcacgtgctggggatggaagtgctgacccactgctcaggtacgcgcgcacctgacgccgcttggtgcgcgccgcggggtactgggtacgtgctccgcgcgcgcgcgcccggcaaagttccccgtacgtgcgccgtacgtgggcgcggtgccccagcgc

SEQ ID NO: 24 - DNA, 202 bp, Homo sapiens
agcgagccgggaagggagagcagcggagggctgcagagctgcgggcgcccggaccgtgccacacaccccccgcggggcacggagggcattgcggggggagacacacaaagacatgcgaagaggggctgaacgaggctcgcgcacaaagacgccggggcgcacggcagctggggctgcacccaccgcccccgcgccgcgccgt

SEQ ID NO: 25 - DNA, 221 bp, Homo sapiens
cgcgccgctgggccaggcggagagaggcggacggacttcaggggaggcccgggccacgccgcggaaactacccgactccctggaggcggccaggaccgaccctgtcccgacaaaatggagttccccgtgtggcttcagctcgcggcgcgttcccagagctcctcagtgatccggctttcggattgttcgcctttcatctcatttgccgttgtccaaattct

SEQ ID NO: 26 - DNA, 225 bp, Homo sapiens
tctgccttcctggcgtcaggagagtcggacgcttggccctttcccagcccggcctcgtatagggtccgaggagcccatagctgcactcctagttaggtgggaggtcggactccgccgacaaatcccaaagagaggggtggggaagaaggagataccagccctgaaagcgaaaagccggagaggaaagtcctgaaaagccgccaggaattcccaaggagcgcaggg

SEQ ID NO: 27 - DNA, 232 bp, Homo sapiens
agaggccgcagtgaggggcaccgagtggcgggctcctccgcaccacccccgggctttataataaaagtcgccgttgtttaagagccaggtcggaggcgccgctttctgggcggtgaaagccgaagcgagagcgggcaattcgctgcggcggcggccgcttcctgggcgtcggtccagtgccccggcccggcctgggagacccgcaccaaccccgggagggaggacggggcgc

SEQ ID NO: 28 - DNA, 214 bp, Homo sapiens
cgccacacaaaacaagcatccttagcctgaagggccccggccgaagggccggaagtggaagtgcgcggccttgcccgccgcgtttcccctcctcggagtgctttttgtggaccctgggcaaggggctcttgctacatagagaggagcaaagaacaggcatcgcccggtccttaaagcggcggcaccctccacgccccgcagtcgcgtctgcttg

SEQ ID NO: 29 - DNA, 194 bp, Homo sapiens
cagcaccgtcatggacacacaacgcgggtgtcctgagatttgtggaccccggagatgcaaagacgatggcagcagcgttaacaactaattacagtagcggcgaccgcgccaaggctttccttcaaccctgattccgcagatatccggaaaactcttaccctccctcgatatgccgcccccatccgcagccacat

SEQ ID NO: 30 - DNA, 346 bp, Homo sapiens
ggcgcaggactccacgagcgagaacagcagctccgtgggcggcaggtgccggagcctcaagaccccgaagaaacgctccaatccaggtaggcggctgggcgcagggacgcgggtgaggagggcggcaggtgggcgagctgcccaaaccccactgccagggtgtcccgtgccctggggagggggcgtccaggcctggcctctccttgcaggtgggcgaactgcccaaaccccactgccagggtgtcccgtgccctggggagggggcgtccaggcctggcctctcctttcccacggcccggcaccccgcggggctccgccggggacatcaccgcggagggtttctctg

SEQ ID NO: 31 - DNA, 211 bp, Homo sapiens
caggcctggcctctcctttcccacggcccggcaccccgcggggctccgccggggacatcaccgcggagggtttctctgtgagaaactgccctactgcgtgccgtcatcaggcttagggccgtgaatcccttggcgctcagcagggtggaaaggcgagggcccggatgcaggtggcagcatgacccgcacctgctcgctctgggggcagcct

SEQ ID NO: 32 - DNA, 235 bp, Homo sapiens
ggtccgcggctgctctgcgaggcccagcgcgccccaggtcgcggctccccggccgccagcgcacctttccatctccagggaaaatatttagacgggaaactcgagtgcaccttattttctctttggtttatgagtgacccagaaggcttctagctcacaatcgcacgatttcaggacgaggctgccggagaagcgctggcgaccgaggatgggggaaggacaaagaggaagagga

SEQ ID NO: 33 - DNA, 325 bp, Homo sapiens
cgcatccgcatcccgagaaaactttctttgctccgaagccggacgcggccgggccaaccctgcccgagacagaagccctttgttcccgcctaggtggctcggaggagatgggtgatggccaccttgggcctctttaagacctcccctctctcggcctcgtggccctcgcggggttccgcggcctggtcttttccccgcagcgcggccaactttgtccagagtcggggtccgcggcgagcgggggatcccgctgcccgccgccgcccgccgccgcccggggtctttggtacccggtgcggaccttatcaacttgttcttgaagtgg

SEQ ID NO: 34 - DNA, 234 bp, Homo sapiens
taggcggcccctccccagggctgcctcccgcgcccctcggcccatttcccggttcgggcgtgcgctcctctgctgcgacccacggagtgcgacgggacagccacgttttcacatcgggccccgtgaaattgccgccaatggaaaggacttggtccagaaaaacgttagtttcatatggttcgcccggtacttaaatgttttattttctcccccaacagaaaactaaagcagctg

SEQ ID NO: 35 - DNA, 202 bp, Homo sapiens
gaggaggacgcgttcggcctggggggactgggtggcctcacccccaacccggtcatcctccaggactgcatgtggagcggcttctccgcccgcgagaagctggagcgcgccgtgagcgagaagctgcagcacggccgcgggccgccaaccgccggttccaccgcccagtccccgggagccggcgccgccagccctgcgggtc

SEQ ID NO: 36 - DNA, 222 bp, Homo sapiens
gcctccttggcgttcctcggtgcgcgctctacgctgcgctcctggacgccgggagcagggcagtgcgctgcactgggcgcccgcaagggaaaaacgctacctgtggaagtaatgtaggcagaagaggcccagaagtaccgtcccaggtggcccgaagagggagaggggctgccgggcgaggatccccgcgggcaccgcgaaggaaggcagctcctgcaggaa

SEQ ID NO: 37 - DNA, 289 bp, Homo sapiens
gccgtaagtgacggctgtcgcacgactgccgcgcctgcgcagaacctcccggcggacaagaagctgggaggcgcgcagaaccatcgtcagtccccgaggctctctgcagtccgcgtgagtcctggccaaggtctggcctcggaagctacgagctacaatcttccttcatcctacccacccacgaagagcgccaccccagctgcagaccaagtgaccagcccagttagaaggggctcggccggatcaaacctcggtgctgcctcaaagcatctgctgaagctcttcctcg

SEQ ID NO: 38 - DNA, 199 bp, Homo sapiens
gcagtcagcctagccaccttcggaactctccacgcctgatcccgttccccggagcccgcggccgttaccttggtgcctccgagccgtaacacttcctccagggagaacccattctcggcttcactagtattatcctcatcctcctcgtccggatcttctactgcctcctcggggcgccaaggccgcttggcatggaact

SEQ ID NO: 39 - DNA, 244 bp, Homo sapiens
tcagggcccggcagtggactcgctgcggggcctgcggccaggacggcgccgggttcgcagtcgggatgcgggaaacaggtagaggccagaatacgagccccaaagagaagagtgggcgcttccccaaacgggtcggcgcagcggaaaaggctaactgaagcaagcgggaggccccgcaccgaggccctgcttcccggggagcagccaggcacagcggacaggggggccgcgctttgttaccggc

SEQ ID NO: 40 - DNA, 282 bp, Homo sapiens
ccgccttggttcggtatcagggcctgggatcctgctggtccagattcaccggccccaggcagactggatgaaacacactgggccgcgatgctcgtcagatcccgaccactcctggagcaggaggcggcagacacactgacaaacagggtgacgcgcacaccgtgcgcacaacgcgcatcacttgtccgcagaagtggaagacgtacctggctcgcagagttgggtcccgagccggctgtcgggaggtgctgcccaagggtcagaggtccaaactggacttgg

SEQ ID NO: 41 - DNA, 231 bp, Homo sapiens
gcgcggggcgctcgggacctgcgcgcacctcggaccttcaccacccgcccgggccgcggggagcggacgagggccacagccccccacccgccagggagcccaggtgctcggcgtctgaacgtctcaaagggccacagcgacaatgacagctgacaaggagaagaaaaggtaagcgggcgtccgggccgatcagggggccggtccgaggccagggccgggctgcgcggggca

SEQ ID NO: 42 - DNA, 231 bp, Homo sapiens
ctcaaacccgctccatctattaacgttctcttctgcccagccacgcccccggcgttctccgtggttgcgcacctgacgtacatcgttcaaaacgtgcccagtgtttccctccgagggcactgcgtgccgcgcaggcgcaaagggccaggtgctggaggtgctgtcatggcctgcctcaacccggtggtaaggaagacctcaggctctgtgtagagggagcgccctgggact

SEQ ID NO: 43 - DNA, 246 bp, Homo sapiens
cgccgccccgccgcgcgtcgctcgcaggacttcagcctgacagctgctccggcctcccgcccacatacccgctctcgccgcgggctggacgacgggaacgaggctcaaggctgattggctctgacgcctgctcatgtagccacactttccgcctctgcgccttagcctacttcctattggtcgagagaagtggagccgggggctgattggcttaaactcttaacagctacaaccggccttcgcctc

SEQ ID NO: 44 - DNA, 221 bp, Homo sapiens
cgggaagccggcgtttgcacacattttcggacgtcatattaaagcgcaccggacgccgagacttctgggagatgaagtccttgcgaaggccccgcattgattgggagcgcagtcgccaggaccctgtgcgcaggcgcgttggtttcccgacctgaagaggcgccgtcttcccgggtcccgagcactctgtgccggaggtgagggttgtgggtgtgtgtctt

SEQ ID NO: 45 - DNA, 339 bp, Homo sapiens
caggtccgcctcagcaaggtgcccgcgcccaccttccaacccaaaaggccggcgcggaagggcagcataaaggcagcggccacctgcggatacccaagtggccttacaaggtggccaaggaggagaaacgggaggcggaggaggccgagaagaggcgccaggccaaggtgcaggagaagcgcccgccgccctggaagaagaggacgtgagagtccgcgggtgcttggcacggggtttgagggctgggtgaggccgcggggctgggcaccatggcagctctcgggaccaccgggcagcgcgcgtttccacgctgtctctctaggatgctcccagaaaggg

SEQ ID NO: 46 - DNA, 224 bp, Homo sapiens
ccgcagcagcgcgttccaaggcactggccgcgcggcgcgcacgtggcgccggcagaaggccaggaaggggcggcagtccagcagcagcgtgcgttccgcctcccgcggatcccgcagcagcgtgcccagcgccgcgcactccagctcgcgcgccgcctccagccccatggccaccggtgcctcttcctcttcctttcggtctttcccgcgtcccgggctctcgt

SEQ ID NO: 47 - DNA, 302 bp, Homo sapiens
actgaccgggcttcaaaccccggtactgtgtgaagatgcgccagacgcccgggttccctccttaagcaattgatttacagtgacatctagtggagaaagggacacacatgaactgacattttcctatgtccagagcaaccgagaaccacggcccactcaggttcgcgggaaggagcactgcgccacggcgttttcgggattcgtggcctgctcccgcagggcacagacactatcttctgtcctttgagtgcccgggcagcattgcgcctgagtatttgtaaacggagggccggtatcccatc

SEQ ID NO: 48 - DNA, 205 bp, Homo sapiens
ccgcggatcgcagggccccggcgcagggacgggggaggccgcgatcggccgggagaacttaaccgtgtttattacaactatttatgttcgcgcacaaagctgctgtcacattgcataaaggaggtcctcgcttcggcgaagggagcttttgtgcccggcttcaggctctgcgccctgccccagatttacaggactctaacagcca

SEQ ID NO: 49 - DNA, 221 bp, Homo sapiens
ggtgatccagaaactaccccggcagggagtgggggagcagcggatattccggggtaggaacggccatcgcaacgctgacagaggttgttttttaagaagcaaaactgttggcggcgacctgagcgctggaagccgaaggggaagaggaaggagacgcgaagccagggcggccggcacaaaggcggcggactcgcggcggcagcgcctgcccggccgggagc

SEQ ID NO: 50 - DNA, 266 bp, Homo sapiens
ccggggccgcggcagctctgggaactccctctcgccgcgcggcggcggccggcgggggctgcagctccgcgctgacttcccctccgccttcgacctccgcactcgcctaaaagtacggcgcggcagcgggcgagactcgagcagctcgggcagccgccgccctgcgtgccatggacgggagttcgcgcgcggagctggcggcgtcgccgactctcccggcggcagcggaggagcagcgccgccgcgtccccacctaccgcggcctc

SEQ ID NO: 51 - DNA, 251 bp, Homo sapiens
tggcagtgggtcacgtggtgctgcgtgcgcacggaggcgcagggcggcccggtcactgagtgcgcaggcgccgtgggcctcgccctgccccgcggcgggaacgcggccgtgagggtgtggggtgtaggtccgccaggcctgcaacggctgccgagggtcgtgggatgcgctcgccgcgtccctgctcaggcggagggagcccggcccgccgccagggtctcgagtccgggtccaggcaggcgtggaggtgg

SEQ ID NO: 52 - DNA, 243 bp, Homo sapiens
ccgcgcgaccatgcaatggcgagcgctcgtcctggggctggtgctcctccggcttggcctccatggagtattgtggctcgtcttcgggctggggcccagcatgggcttctaccagcgctttccgctcagcttcggcttccagcgtctgaggagccccgacggccccgcgtcgcccacctcggggcccgtgggccggcctgggggggtatccgggccgtcgtggctgcagccgccggggaccgg

SEQ ID NO: 53 - DNA, 200 bp, Homo sapiens
aacttggctcgggcatccatcgctctggcctgaactcaggccccgcccccggggcgtggcctagcgatctggtggccgccatttcgaagctgaagaggttaggcgacgctgacttgctttcaggagaggcactcggtaatcgagaagaaccggctttcggccagccaggagtggccagaggcctagaaggggagaggaag

SEQ ID NO: 54 - DNA, 217 bp, Homo sapiens
cgcgcgcctgcctcggcgccctcgcaaccgcggccaggccaacctcagccggaaactacatttcccagcaggtcgcgcgctcctcgacagctctccaggcagtagaaactacatttccccgaaagctttgcagtgcgcaggcgcatcaatgaggtactgcaatgtcccggaccgtatagtttccaggacgtctcgccgcgcgcatgcgcagaaacac

SEQ ID NO: 55 - DNA, 277 bp, Homo sapiens
tagccaaattaccagtgccctggagccggttgggttgagcgcccctgcccggggaaggtagcctgcgggctcttgccccgagcccgcggagcaggaggtctcttttccaagcgcactcacattattcatgcaaagttaatccccgccgcgtcacggccgcccgcccgaggatgtgcgccttccttggccaagccccgcagtctccaccctcctccgccccctcctcccggcggcggggtcccggggagcgccggcgactgggcgtcgcgcgagtcct

SEQ ID NO: 56 - DNA, 230 bp, Homo sapiens
cgcaccaacgccgccgccttcgccgggagccaagcccgccgggccggcccggtcccaggtgggcagctcggcttgcagctggttggaggtggcggccgctgcagccctggcagcgggcacacccctaagcatacgcacccaacgcctcctccctgagccacgaggatggagcagccaccccggcccgggactggcgcaaggtaaggtgcagccgcctgttgcttttcgca

SEQ ID NO: 57 - DNA, 227 bp, Homo sapiens
cctagcgtgggcacgcgccactgcggccaaaagacagaaatctttttaccggaagagatgaaatagaaagcaggagccagaggctgacttacagagccagtgtgcggatcagagttccttaggagcggctgctggcgcttgacgggcggaatccttgctgaagagaacgtcaaggcccgggcttcgccctgcatcgaacttactgcctaagaataagacccaaatgc

SEQ ID NO: 58 - DNA, 319 bp, Homo sapiens
caagcccgccttcctgaagaaaaagcccagtcccggcagcgttcttctccggctccgcccttcttccgctcgactttctttgccattggctgacaacggagtacataaggacgtcatttcctgccgcctgtcttttccgtgctacctgcagaggggtccatacggcgttgttctgggtgagttccgtgtagcgtccctggcgccttccagggctagaaaaatgagcttttcctgctcaaatgaagggtgagaagactagtgatgaaagccggtcagactggatctgtctcccgcccggcgcgccccaccttaggcctgc

SEQ ID NO: 59 - DNA, 205 bp, Homo sapiens
agagtccagccggtcttccgcggcacttacgcgctcgtgggtccaccgccgggcagaaccgaaactttctggggccaagcggaagaggacgggaacgcggtgctgacggccatgacgcgcacaccaagagggtggcgggggcggactacaactcccggcgtgctccccggggctgaggcctgcaactcccatcggactcccgggg

SEQ ID NO: 60 - DNA, 218 bp, Homo sapiens
ggaaccactcaataaacacgtttacccctgcaagcggcacatcagagtccgggggtaattctcggtgtcgtggggccaggacggcgaggggctggaagaggccgccctgtgggagctgggaggctgagataaattcccgtgattgggggctgaaatggcctcccatgccggactgccgtggttctagaactttttcctggaacaggccggcactccca

SEQ ID NO: 61 - DNA, 205 bp, Homo sapiens
actcgcggcggaggcaagcggcggcgcgcggacggttggtccagttctccggcctggcggcaggcaagtctagctcggcgctgtcggatacttggggtgagcggaaagcatggcggggacctccgcgccaggcagcaagaggcggagcgagcccccggcgcctcgccccggcccgccgccgggcaccgggcaccccccgagcaag

SEQ ID NO: 62 - DNA, 230 bp, Homo sapiens
gagggcggggaacgacgtgcgcgcctccgagtgcccagcgggctcgagccggcacaggtcgcggccccgcgcacgcgcgcgcactcacagctcatccactattgctcaggagcccgtccacgccctaaaagcaaaacccttaaccaatcattgcagccgcgtggggcatcacgggaactccggggctataaaagacctggttgctattttgtactcccggagtcactcat

SEQ ID NO: 63 - DNA, 232 bp, Homo sapiens
tccgaggcctgtccttatgacgcctgcccgctgtggcactccggttacccggaggagagttgctactctcgagttcaccgaggcggaaagcccctctgactccaaagcagggctcagcgcgacgtcccagaggccgcttctagtggcaggtgcccctcctcacagggccctcgcagccccgccggcccccgcccggctccttctcagcatgatacaaccgcgtcggccctgg

SEQ ID NO: 64 - DNA, 316 bp, Homo sapiens
tccacctcctccaacgaagcggaacacgtgacaccaccctatccacttccggcttggagggcatgccctcccgtcaccagcatgcactttcgacaaaaccgtggaatctagtattttcctctgacacctttatattttcttcacttccctataattctgacctatcgtgtaggtaaaaattaatcttcagagtattacagacatgcgtgcccacgcgctaggcgaaagtgcgagtcggaagcacttcattccctctcttcgctagccggaagtcgcgagatctgaatgagtcaaagccggcggcctcggctcctca

SEQ ID NO: 65 - DNA, 201 bp, Homo sapiens
ccgccgccgcccgcggtccctgcctgccccaggcccggggcatcgccgccggccgccgactccgcgccctgcccgatcggctctctcctttttaaacggaaagcagcctttctccgccgagaggatcgtccccagcgtggctctgcgttcccggtcactttttgagattttccggggggcgctcggcggcttcccggattc

SEQ ID NO: 66 - DNA, 279 bp, Homo sapiens
cgcctcggccgcccaaagcactgggataacaggcgtaagccaactggcccggcccagaagaagtttttaggatatatggaggaaaacacaacacaacacagctacaactccgtgacaactgagagcgtagtcttcgagtacccagttgcctactgacagccgtctcctctaaggcgcttcttttagccaagaaagcgttctttgcgtgctgtgacgtaaaaagcagcgccggaagggagagggcggaacttccggctgagccccagcgaccgctctggt

SEQ ID NO: 67 - DNA, 306 bp, Homo sapiens
gatcccgcagcagctgatgaccaccctgggacccctgttccgcaactcccggctggcacagttccacttcactaaccgagactgctgcttgctcagtgggctctgccgcatcatgggcaacggcttcgcgggctgcacgctgtttccccacatctccccctgcgagatgtgcgtgcgcatgctcctgtactcttccaagaggaagatcttcatgggcttcatcccctacgaccagagcggcttcgtcagcgccatccggcaggtcatcactactcgcaagcaagcagtgggacctggtagtgtcaa

SEQ ID NO: 68 - DNA, 309 bp, Homo sapiens
agagtagctgcggtgcctgcgtcgtctcccgtgcctctgagtgctctcccgggggctgggcctgcggggcctctcctgacagcggctcctgaaaggagggtggctcggccgccagcgtgcctcactggatgaggggacatcgcttaggctgtccctgtctgaccagtgtatgggtgacccattcagcctagagctacggtgccttccactccacgatgggtccaactcccttctttccaatgcccaagactttggcccccggtcctggagctcctggtggaaatcagggtaatggtggtggcttctccc

SEQ ID NO: 69 - DNA, 197 bp, Homo sapiens
cctcccacctgcgcccgccgtccccgctcctcgtgcgggtgtacaagtccggcccccgagtacgaaggaagctggagagctacttccagagctctaagtcctcgggcggcggggagtgcacggtcagcacccaggaacacgaagccccgggcaccttccgggtggagttcagtgaaagggcaggtgagcttcgggcg

SEQ ID NO: 70 - DNA, 203 bp, Homo sapiens
tgctgctgcacttgctccaggagccccaggaagcccagaagatgggcaccgggcaaggcgtgttctcattacagaacctggggtcgggggagaggcgtcaatccagggagggggacccccttccctgacgagaggtccctgggagtgcaagaccggaaaggacgagagtccccgggatcacgaggagaatccaggccactttc

SEQ ID NO: 71 - DNA, 409 bp, Homo sapiens
gagggaggcagcagagcgggccatgcggcagcgtgaccgggaggctggccggggcctgggccgcatgcgccgtgggctcctgtatggtaggtccagttgtctgcctgcccgagggactgggaagctgggaaggagtctgggaggggagtagaaggtgctggggatgaccgcagtagcaggtgtctcttgcctccccagacagcgatgaggaggacgaggagcgccctgcccgcaagcgccgccaggtggagcgggccacggaggacggcgaggaggacgaggagatgatcgagagcatcgagaacctggaggatctcaaaggccactctgtgcgcgagtgggtgagcatggcgggcccccggctggagatccaccaccgcttcaagaacttcctgcgcactcacgtcga

SEQ ID NO: 72 - DNA, 220 bp, Homo sapiens
tgttttgccggaaacgtaaaagacagggaccggaactgaatgggagtaccggaagtgcccagacgaagcggacgctcacagaaactgaagattctaactgcccacagacactgttttgtcggaaacgtaaaagaaagggacaggaagtgaatgagagtactggaagtgcccggacgaagccgacgctcgcaggaactgaggattctaactgcccacagag

SEQ ID NO: 73 - DNA, 335 bp, Homo sapiens
actgcgacagcaaagagctgcagcggcggcggcgtagcctggccctgcccgggctgcagggctgcgcggagctccgccagaagctgtccctgaacttccacagcctgtgtgagcagcagcccatcggtcgccgcctcttccgtgacttcctagccacagtgcccacgttccgcaaggcggcaaccttcctagaggacgtgcagaactgggagctggccgaggagggacccaccaaagacagcgcgctgcaggggctggtggccacttgtgcgagtgcccctgccccggggaacccgcaacccttcctcagccaggccgtggccaccaagtgccaa

SEQ ID NO: 74 - DNA, 197 bp, Homo sapiens
taggcaagactaactcggtgttgctcctcccggcgctgacttcgaggcccggctatggacggcgagagcgaggtggatttttctagcaacagcataacccctttgtggcggaggcggtcgattcctcagccccaccaggttctgggccggagcaagccgaggccccagtcctaccagagccccaacgggttactaat

SEQ ID NO: 75 - DNA, 235 bp, Homo sapiens
gccctagcccaccggcgcgtcccgcagttccgaactaaacgcgccaggccgggaaggctcgggctgtctgaagagaggcgtgacctcgcctacaccagatccaaggcgcacataccgagacacccctcaacctcactcagcagtgccgtttccaactccgcggcagagacagcgcctggcgaccccgggggtagatccccaccggggaaaagccgccttaaggaggagccaactg

SEQ ID NO: 76 - DNA, 320 bp, Homo sapiens
ggagcagctcaccttcaaggacctggtgtcctgtgcctaccaggtggcccggggcatggagtacttggcctcccagaaggtgggcagggcggcaggtgtgggtggagtaggctgggccctgccctgagatgctgggagcagcggggagaggtggagaggcttcagccctgcctcccaccccttccccagtgcatccacagggacctggctgcccgcaatgtgctggtgaccgaggacaacgtgatgaagatcgcagacttcgggctggcccgggacgtgcacaacctcgactactacaagaagacgaccaacgtgagccc

SEQ ID NO: 77 - DNA, 263 bp, Homo sapiens
agaaagaaaagaaaggactagacatgtccccattacctgcctgcgctcccggcgggtcaggctgtggccgttgaggatgcgccagagcatgcgtgccgcgatcttggtgtcgatccatagcaggcggaagccatggtagtagtgcttcagctcgtccagcacccgctgccccagggacttcttcaccaccacctctgcgggggggctgtacaccgggccgccttcctccagcttcttgttcttgtccttcaaggacttgaggg

SEQ ID NO: 78 - DNA, 214 bp, Homo sapiens
cagggagcacatggcaacgggctgcgggcgagctggccagcggcccgcccggggtcccagcccttcgaagaaagggacattcacgagcttctatctctaattctctgtcgcaggcatttcggccgtggaaccccaggctcggaggactgggtgtgagcgctgcccgggagaggctgacctgccgggaccggagtgcccggggacgctgtgcccc

SEQ ID NO: 79 - DNA, 242 bp, Homo sapiens
gccttctcccctgccccctcttccctgcattcaaggagccgggcggccccgggggatatttttagttgcttctttctccttcacttttagctttagcagcatctcgaaacactcaaagcggagaaagactggggggttggggggagctggagagggagtgggggaaaagttaagagtcgcgcaaagaaaagccggagggagggcggagagggaccgggggcgcgggtggaggaggggaaggg

SEQ ID NO: 80 - DNA, 220 bp, Homo sapiens
ttccgcgaaattgacggaagagtccgggtgtttcttcttgtgctcttcccggcaggtctgcacgaagaaggcgtacgaggacattttgccccgcggcttgttggggtctcctttacccatgttgacagatccgcgtccacctgacggggccgaggggggagaggggaagccggagggtcggcgcggagcccgcagctgccagggcgggcgctggcggggc

SEQ ID NO: 81 - DNA, 214 bp, Homo sapiens
cggagaaccacccacggggctttaaaaatgttggtgcccaccacctccccggaacagggcccgctctacctcggtcggggagcgcgggacctcagcgttcccttaacgccaccgtccgcgggtccgctttgcgcaggcgcggcgcccccactcagtacccgctccgggcgtggcatggtgcgcaggcgcgatgtcccccactgcagccccgctc

SEQ ID NO: 82 - DNA, 296 bp, Homo sapiens
cccgcccgcggacaggcgagacgtgggccgccatggccgcacgagtgaccgggggccaggagagccagtctctccccagcctccacgacgtctggggctcccgtggggcgagcccttgctagtgtcccatgctgagtggcgggtaggggaatcggaattccttgtcctaggctgggagccgtgtgggggctccatgtttcgggctggaggagctgggcgagtgggaggggctggacctagacgtcccgggctgggggtcccggggagcgggaatgcagtaccccggctggatgagc

SEQ ID NO: 83 - DNA, 212 bp, Homo sapiens
gggccctcggcgctgcaggagctgcccagaaacttttccctgctctcaccgggcgggggagagaagccctctggacagcttctagagtgtgcaggttctcgtatccctcggccaagggtatcctctgcaaacctctgcaaacccagcgcaactacggtcccccggtcagacccaggatggggccagaacggacaggggccgcgccgctgccg

SEQ ID NO: 84 - DNA, 213 bp, Homo sapiens
ccgtggtcctcgcacccttgcctctggtgccgactagcacccaacaccccggtccacttgtgcgagtgagagcgctcggcgaagtcttatatacggggaggcgggaagggggcggagactcgatacgcgacatcacgtcacggcctatgccccgccccacggccggccgagcgcgcgtggccgggaagcaagtcttgtcccgccacccgggtc

SEQ ID NO: 85 - DNA, 225 bp, Homo sapiens
gcgaacgctgagcgttacggggtacgtggtggcccctcaggttaccgaccgggtcggttagattccagaggacaaaaggcagggaacagcctggtcttggggtctttaaacagagaggcgccatctactgccgagaacccagtcaacatctcatggacaaagctgcactaacccccggccggctgagctctgggccccgttagcctttctttgaggctcgtccac

SEQ ID NO: 86 - DNA, 202 bp, Homo sapiens
actacaagcggtcctcccggccaccgtactgttccgctcccagaagccccgggcggcggaagtcgtcactcttaagaagggacggggccccacgctgcgcacccgcgggtttgctatggcgatgagcagcggcggcagtggtggcggcgtcccggagcaggaggattccgtgctgttccggcgcggcacaggccaggtgagg

SEQ ID NO: 87 - DNA, 191 bp, Homo sapiens
tcacattccgctcccgcaggcctgcgggccgccccagctggtttgttcccggcgtgttagaggtcagaggccgaggccgcactcagtgcctgggtctcgcgcagctccagggctctcaggcgacactgggcgtttcctttccggcttcggaaagttttgttttggttcaaggaaaggcgccctgttgacca

SEQ ID NO: 88 - DNA, 196 bp, Homo sapiens
gctggaggagttccagaaagccaaggccggctccacaggcacccgaccccggcctgaagcgcaggtctcctcctgaggcccgacaaccacctgccccgcctcgtcctcgcctgtgtcccccccgtcatccccgctccaggcgcccccggggagccagcctccgcagccaccgtcaagaggaagccgaagagccggt

SEQ ID NO: 89 - DNA, 216 bp, Homo sapiens
agtgtagccggagtgagaggaggggccccggacgtagcctgctcttccccggtgtggagccattacggggggacattcctcctgcggcggggggagggagccccctttcttttctttgagaggtcagaatccgcagtccgcccttcgcctttaaataaaagcctgccggctcgagatcggcgtcgcgatggagtgcccgtggacttctacgcttgc

SEQ ID NO: 90 - DNA, 238 bp, Homo sapiens
gggcgggccgggggcgggggcgtggggcggcccatttcctcctcctagccggactggagggagacaaagcagcgcccgtctgcttcgggcctctggaatttagcgctcgcccagctagccgcaggtaacttcgtacctccctcctcgcgggcgcggtctctcgggccaggccgagagggtccttgggccgggccgtcccaagctgggccccgcgagccgcgggcgggcgagcgggcgg

SEQ ID NO: 91 - DNA, 277 bp, Homo sapiens
gtcgcaaaaggtatatatgattaattgaaagataagctggaactatcaccgggaatgtcattaatgcgctggggagacgtccattggagacaggcggcgttatccgcggctttatcttcaacaacgcctcgctctcggcccgcgcgggggaaacagatgggagtttctgtctgggacgctcgccccatgtttatattttgggaagaatcgcaactcgtgggagtccccggctggccccctgataaatgaacattagcactttttcggactactgtat

SEQ ID NO: 92 - DNA, 204 bp, Homo sapiens
acgctttcatgggtggttacgcgacagttgccaggaccgagggcgaaaccggctgcaaggcattgtgggacattggaggacttggaatatgcgctagaaggctcaatccaagcccattggaagaggaagacgtacgcagcggagacagctgatccggagtcggggcggcctgccaggtgcccaacctctcccagagcatggcgt

SEQ ID NO: 93 - DNA, 215 bp, Homo sapiens
ttggggaagcagctccacggggacccaggaggcgccggccgggttgagccgggttggttccgacccaagagagctcgtcccacgacggagcaggtccctttgcatcccgcggggccgccaggtgcaattttcgctgggccgacggcgcggagatgggccagagtccggccatccagaagtgcctggagcgcacagcaaggccctgccctcggctc

SEQ ID NO: 94 - DNA, 208 bp, Homo sapiens
ccgctcctcctccctgtaacatgccatagtgcgcctgcgaccacacggccggggcgctagcgttcgccttcagccaccatggggaatgggatgaacaaggtaacgtcttccctcgttcgcgctgggtttgcctccgctccgacgccctgccgtctcgccggcgtcggctgcccgacgactcgagcccggggtgccctttcccgcggtg

SEQ ID NO: 95 - DNA, 242 bp, Homo sapiens
caggtggacatgcgagagcgtgtgtgtgcgtgcacacactctggggggccgggcgggggctggagggcacccaaaagcagcagagcctcctcacctcgtggctccttggcccgcggaggctcccgcttgcgccgtttccgagacggcttcacccatgggctgtcttttcgccatttcttcttggccttgcgccggccactggaaccactctgggaagggggaggaggaggagttaggaaccc

SEQ ID NO: 96 - DNA, 207 bp, Homo sapiens
ccgccggctcgccccctgaggagggggctgggccagggcctcggctgaccggggaggaagaaggggagcagagaaaaacatgagtcacagccgtgtgtcactggagcgcatttcaattccctgcatcacaggaggtgtggaaggccgcctcggggaccgggcgcgggaggtgcgcccgagaaggccccgggccggcctgcagggcgc

SEQ ID NO: 97 - DNA, 201 bp, Homo sapiens
tggaaaggagtcggttgtttggaggtccccgccccgcggggaagggctccggatccgaccctggtaggtggggagcagcggaccagcccaaacgcggagccaatcccgccaaagcccttaattgcacgcatctaagatggccgcccccgcccggtagcggggcggaaacgagcccctctagcttgctagccgagcccacac

SEQ ID NO: 98 - DNA, 287 bp, Homo sapiens
ccgggagggacggggaagtagttagacaatagtcaggggaggttattcccgggacaaaaagcacctggcaaagcgcgccgaggtcagtcccttcgaatctccacatttctgacaatggcttcccagggaatttgtttaaacacccaagtggcagacagcaacaaacccgcaccacaagcaacagagtgccgtcacgggagtcgtaactactttttctttctctcttccccactagcccggcgcaggccacgcgagacgccgaagccagcaggtccccacactctccg

SEQ ID NO: 99 - DNA, 245 bp, Homo sapiens
ctgggtaagcgtccggcacctgctcgccgcggcgggagggccgcgcggccggggctgaacccgcgcctccgcgcgtggggctttcgcggagcgtcggtcatgggtgccgttctggcgattgcgagagtcgcctcgggaaattgatgtgggatttgagagtcttggctcgggcgtggacatcagccgcctcccctccggtctctttcactctccgaaaccttcctcgggaaccgctgtcctccctg

SEQ ID NO: 100 - DNA, 223 bp, Homo sapiens
acccggcccggcttctgccgacagctgggcggggacgcgcacgcagtcccggcggggacgcgcacgccgccctctgaccccgcagcgtcgtggctagagtagggtctggagagagctcccactgtggcgagtcctgtcgttggattcccgcggcgccccgtaaggctccgccccggcggtgctaccaaaccctgttcgattttagaatcgtacattcccagag

SEQ ID NO: 101 - DNA, 193 bp, Homo sapiens
gatctgggaggcttgtccctcgccgcccaccgtagccccggcgctcggccggtcgccgtttccaagatggccgcggcgcgcacggctcctgcggcggggtagaggcggaggcggagtcgagtcactcccgcacttcggggctccggtgccccgcgccaggctgcagcttactgcccgccgcggccatgcgggg

SEQ ID NO: 102 - DNA, 265 bp, Homo sapiens
gcgccgcggggaccccgaaactttccggagcgcgctgagagcaaaaagccggctgggcagaaagagggggagggggctgggcgcgccttcgagtgcgctggggtagccgcggcgccccaagttgaaccacagacgaacccctcttcatctgaaacctggtctcggagtcggaggtggggagggagtgggctgtgggtgcctcgacttcgcaaagccggcgtgggggggcgcagcgccccgccccgcgccgcttgaacctccggag

SEQ ID NO: 103 - DNA, 205 bp, Homo sapiens
gcgcaccggggctgccggggcgccacgtggtgcgcacgtggtccggccccggcgcggcagctcccctcccccaccacgcgagcctggccgcagcgcccgctggcggcgcggcgttgcacattgcgcgtgcgcacaactcgccgcgaggcgccttccggtggcgcggcggggtcggttgcctcctcgcgacggctgcgccgggatg

SEQ ID NO: 104 - DNA, 255 bp, Homo sapiens
ccgtgcagcctgggcgctactctctgccgcgggcatggctctgaggccccggctcggagaagcagccgtggccatgcagctaccgagagcgggctctggcttaaccgcgtttctttttaacgtctctgcctgcggtggggggcattcctacgatgagcctgggaggaacccgaggggctgctgccatgggcagaggggtcacgcccgggtcccgctgggccggcggctcacccagcttcaggagccagccctcgc

SEQ ID NO: 105 - DNA, 207 bp, Homo sapiens
gaggcggcggtggcggcgcccacccccagcggcaaggtggaccccgcgccggaacggcgcttcctggagctgggcaacggcctgggggagggcgaaggcccctcctcccacccgctgggcttccacttccccgtgcaccccaagtcctggctgcacccggacagcttcccgatcctgggcctacccgacttccgagagcggctgccg

SEQ ID NO: 106 - DNA, 230 bp, Homo sapiens
gccggggagggcccgcgcttctcccggatggaccgggacgccggccttccgggcccaggaggcctcccatcccagtctcccgcggcgccactgcggccctgcctcgtccgaacccctctccagggacgcgcaggtcagggacacccgtccacctgcgtctgccatcgcttcggggcctgccggtgcccggtcctcgttcagctgcagcgccaggcccaggcctgcactac

SEQ ID NO: 107 - DNA, 338 bp, Homo sapiens
ggtctcagttgcacagaccaggaaactgaggcccacagaggcaggtgtccggttgtttgcaacctctcagcctgtgctaaccccaattgttcagagagagccctgaaaccctctcctctgggcgcccccaggtgactgccccagcctcaagggctgcctctgttgcaggaaagacgacgtcacaggctacttcccgtccatgtacctgcaaaagtcagggcaagacgtgtcccaggcccaacgccagatcaagcggggggcgccgccccgcaggtaagcgggggtccccggggctgggcggggtcgagcggggcgcaccacgggttcgctctgtctag

SEQ ID NO: 108 - DNA, 347 bp, Homo sapiens
gcgagtccccggtgccccgccgggatgggcctgtgggccggcaggactccgggcggccctacagcttggtgggctgctcggggctgagggggccaggcccgctgggcgggggcagcaccatgggcagcgagttgctgcccctctcgtgccagcaggtgtccaggatggggtagagcttgccctggaagtcggcctggaaggtgtagagcggccgcaggtcatcggggcggtcggcatcgaagaaggtgagttcgccctgctcatagtgcaggtagagcccgatgcggtgggggtggccggccacgggcaggggtacccgggggcaggcaaaggcttcgtacacccgg

SEQ ID NO: 109 - DNA, 248 bp, Homo sapiens
accaaggcctccggggcagccgacggggccgagcagaggagcaggctcccgggcgcctcccgacacatggacagcacggtgggggacaggaggttgaggctgaccagccgctccccccacagccaggcgtcgtccaggtgggggtcaatggcagagccccgctcggggcagtagtccaggttgcactgctcgacgggccggaagccctccagccccgggtagaggcccatcctccgcaccacctcccg

SEQ ID NO: 110 - DNA, 213 bp, Homo sapiens
ccctccctagttcccagcccccagccctcggtgacacttccccgccccccggttgtcaccccgtctggtgctcgcagaaaatgtcactgtccccattttccccgccgatcccccaccacggccgcactcccgcaccctctccgctgctcttgtgggtggaccccggaaaggtcaggcgtcctggggggcagtgcccctccccggaaagttggg

SEQ ID NO: 111 - DNA, 234 bp, Homo sapiens
acgcccccttccggccgaggcgcggaccgcgcggagctaagtggaatcccggttggcttggggcgcaggcttccaacttcgtactctggcctctggcgtctcggctcgtcggttgggtacccgaacccagctactgctgcttgaagagaagatggatggggactcctcgccgtcgctgcgccgccggccttccctgggcggacgtacacctttgcgaagcgtcagtgaggaccc

SEQ ID NO: 112 - DNA, 276 bp, Homo sapiens
gctgcttgaagagaagatggatggggactcctcgccgtcgctgcgccgccggccttccctgggcggacgtacacctttgcgaagcgtcagtgaggacccagggcccctccttggaatagctcttatttctcaagcgctgcagcgtgaagctcgctctgcgggtccgagaggcctgcgatctgaagactgaaaactgggaagagacgctctaccctgtgctcctcgccggcttcgataggagccgcaggtgcctgggattttctcaaactttgtccc

SEQ ID NO: 113 - DNA, 192 bp, Homo sapiens
aagcggcagcgctcgccattgccgctggtggcaggaggctgcgaggagccggcgcggtcgcagtctccacggcgcaggcccacggtagcgcagccgctctgaggtgagtgccctaccgcgcaatctccagctatttcagccccggcgcagccgcaacacgccgcccgcccgccggccggccggcccgccccg

SEQ ID NO: 114 - DNA, 209 bp, Homo sapiens
ggaagacctggagccgagaggaggcggtggctgcgagcgccacggagcccggctgcagccgcgcgcgggccccatgaatgggttactacggccctggctgcgggaggcggagctgcggcccgataaggagcctcatttgcatggacgcgcgggattggccggcgcctggcaagccgggccgacgtcctccggcggcgcgcgccacgctc

SEQ ID NO: 115 - DNA, 221 bp, Homo sapiens
ggccgggctgggcgcttttgccccgggccccggaccccgggcgtttgtccggtgcgctggcttaagaggcgctcagctcataccgtgattgcacaactggcttgctctccgaactcggtggggaaaacggtgacaaatacagattccaggtctccatctagacccctgcaccggggagccccaggccctaggtccttcgcacacgcccctcccagaggggt

SEQ ID NO: 116 - DNA, 222 bp, Homo sapiens
tacagaagcacacaggacaaatccattcattctccagctcctacacgcccgggaagcagttttactttacagcaagttcaagagtcgcaccgcagatgctgtaaaaacgaaagaagcccacagttgggacgaggattccagttttgcgtcaccgtcaaggcgggaaagttcccggctgtcggttggagggtgggtcctcgccccgccccgccccctcgggcc

SEQ ID NO: 117 - DNA, 262 bp, Homo sapiens
tcgccactctgtcgcagaggggtccggctagccacgaggccccggcccccggcagcccagccccttggcaagcaccctcccgccccctccgcccctgcccgtggcgcggcgacatgggccccatccaggtgctgcagcccctcctccgctgcaggagaaaactctcctgttttcccctccctgccaccctccgaagacctcctacctggtcccggaccacgcccccgtccccaactcccccaacgccccgcgctctgcgggt

SEQ ID NO: 118 - DNA, 219 bp, Homo sapiens
cacgggaaatgaagcactgggctctaccaagagccacgggccgggggcccgggggggggacgcgacccttgcacacgccccgcctggccgccaggaccctcgacgcgccgtgccccgacacttcaaaggcagaattccgttggagatgaccgcggaggccgctcttccccggaggagtctgcacaagtgctgggaacgggcggcagcgcgcgcgccccc

SEQ ID NO: 119 - DNA, 221 bp, Homo sapiens
agatagcagaaaagctcatcaaggcctttgctgagcagatattttacaccggcttcatccactcggacccacatcctggcaacggtaggaatttaccccaggggtgggggtctcggggtgggcgcagcgcgacctaagaggctgtatccctagttctggtgcggaaaggcccggacgggaaagcggagctggtgctgctggaccacgggctctaccagttc

SEQ ID NO: 120 - DNA, 255 bp, Homo sapiens
cggggtcgtcttcagccctcgcggctgtccttttggtgtttctttcccccggcatggggccatttcttcctgcagtgcctggaggaaccatgatgcggtgtagacggcgggtgcttaaataaatgcgagttggattagggcgcgtggactgccaggcacagaacgtggcgtggagtggggacgtggaggagggagccagacaggccggggctgtaggcaggagcttggggttttcctctgtgctccgccagtaaa

SEQ ID NO: 121 - DNA, 204 bp, Homo sapiens
tgaattaggaggttagggagcagtgcaaacaggaaacgagaccctggcccggtctttcagaaacctaggctcgagaagcctgttcggttctcagcatgtttgagtgcttctgggcgcgggcggagcgagaaagcaagtgtagggtggcaggctccggagccggaagaagcccgttcaattcagcaacttttcattaagcatttg

SEQ ID NO: 122 - DNA, 203 bp, Homo sapiens
tgagaaagctcagactcagggccagcaaccccggtcccagcggagcgcccggcacgcgccgacacttcagcaccagtcgcggtggccaccactgtgcgcggagatggctgcgacgcgtgcgcaggtaaagtccatccgtgccttgcctcccaccggcgccttccaccgcctctggttttgtccccgccagcggctccgactcc

SEQ ID NO: 123 - DNA, 229 bp, Homo sapiens
ctggcctgagggttcgcagagggccagtcgttgcgacagccccgcgtcccggcctcctcgtctcttggaccttcaccccaggccagcgcagcccagcttcctgggcaagtttcacgctaccaggatccagtgcggggcgacgaagtggagagctgtatcaagactccgaagagaaattccggcttcgcggggcggcgcggagcccggagctgcccacctccgccgcctt

SEQ ID NO: 124 - DNA, 193 bp, Homo sapiens
ccccgccagccggaaatgtccgcgcgctgaaaagcagacgctgcctgcccggggaacggcgagagagagcgagaaaaaaaaaagcctgaaggcggcgcggcagccagcgagaggggagaaacagattcacacccaggggcctccgggcagggcccacgggactcaggccgtgtcccgcttggaatgtggagca

SEQ ID NO: 125 - DNA, 192 bp, Homo sapiens
cggccaaggccgcgttcctcgcccgctggagctcccggggactccgggccggcttgggcccgcgtcagcacccagccctcgggagcgcaggcctcctccccagaggtccgacttccctgggttgggcagccgcggccactcccggccatccctctgcggcgaagcccaggcgcccgtggcctgaggtcgctt

SEQ ID NO: 126 - DNA, 453 bp, Homo sapiens
actgcagccccggcggatctgagcgtcatggggggctcggtcataaagccgggccgcagcgtgggagctgcacctcggggacatcagggcgcccccacccgcgggatccctgagcgacttggggcactggggctgcaatacagaagaggaagccgaggtagagaggagagaaaccactcgacacagacaatattcaccccagagctgagaagggaggggctgcgtaatcccagcgatggagcccaaggttcaggagccagcaaaccagtcctgctctgtccatcaccctcggggacgggcgctaggggcgagcgctctttggaacaacatattgcgggttcccccaactggacccccgccgagaatggtagtaagtggggatccacgtggtgagcgcggccgccggagttcactcccgacgcatttccatagcgtggggagaggctgtgtgag

SEQ ID NO: 127 - DNA, 241 bp, Homo sapiens
gacgctcgcgcctcaggtactggccgcgggggcgcgcccgagccctggccggaggggaggggaggggcggggggtatttctgaagcgtgcgagccacgctcaggcgctcccagacctggggccccgcgccgccgccgaagttctaacgcggtctctggagccgtctggcgcgcaaggaggaggctacaggccggggtcgtctcgctggcagtcgctgtcagaggggttttctaactggatg

SEQ ID NO: 128 - DNA, 205 bp, Homo sapiens
ccccgccaggccacagaccccgcccagcggccagcacccggcgcaggcccggcagccgagctgcgcggcggcaccatgcaggtcaccctgaagaccctccagcagcagaccttcaagatagacattgaccccgaggagacggtatgcgcgcgggccgggggcaggggcagccgcgtgcgggccgcggggagcgccaggagctcgt

SEQ ID NO: 129 - DNA, 212 bp, Homo sapiens
acgaagaggaggctgacgctgacgaggacacggtggcggccactgactccggaggatgggtcagcgaattggagagaataaagtccaggtccaggagatcgttgaactcctcggtctctctccgaggtaggggcgccaggttgctaccgccgcaagccgcaccggctccgccgctctccaggtctgtggccacggtcgccgccgccaggtca

SEQ ID NO: 130 - DNA, 235 bp, Homo sapiens
caaacaaatcctccagctgctggtacggggaaggtgttcagtgacacaccggaagcagcctagtggctgaggcgtccttctccctaccaacgggttgcgaaggaagtagttgctgtagccgcgccctgtgcgcctgcgcggaggcgtcggctgctgacgtgtagctggggccagacgggactagccgggcgcgcggctgagtgctgcagaatcgctggggtggcagagccgccag

SEQ ID NO: 131 - DNA, 251 bp, Homo sapiens
cctcccgccctcgcgccccttcggcccgtcccgtccagcccgggctgcccggctctcgcaggcccccccgcgccgaccgcgttcctatggacagacgcacagacacctgcaggtgggtgagagcccgcgcgcggggcggggacgagtgcgccgacgccgcgacccaggcggggagcccctttgtgtggggggcggccgcgccggggtcgactctgcttccccgtcagcggccgcgcggtgacccggctgaa

SEQ ID NO: 132 - DNA, 223 bp, Homo sapiens
ctctcgcccctttgccgagtctttgtctggccccagccccgcggggccccgggtccctgtgccctcgggggtccctagaaggcgacaatggctcgagtccaggcgccgaggctggcgagcgcctgcttggcgcacagctgcccgttgagcggcggcggctgctccgaggagtccggctgtcggctcaccagccccgagaagccggagccaaagatggagatca

SEQ ID NO: 133 - DNA, 214 bp, Homo sapiens
gtatttgagtgtgaagcgcctagaaaaccacaggacccctacggcgagccgggaatttttagatattttcctccgagtcaacgctcagtgaaatcagttcaatcagtggcccgacaccgtgcggctgacacagcttatcccccgaccctgagatcaggggtccccggagcccaaggtcgcttccaaagctcagcgaggcggaggtgcggcccgg

SEQ ID NO: 134 - DNA, 430 bp, Homo sapiens
ccagagacctgggccgggctgtgtgcaagagctgacgggcactggtcaccgggggaacctagcaccccttggtcggccccatcgccccccagctgtgcctgcgatgccccctttttttctaggggcctccactccaaccgctgtcccgcactcttgcaggccagcgtcaggccctccccgccaccctgggatctggaaactcactctctgcagtttccatctctgtgtcccgcctgcagagcggcgggactttctttgcctggccgctggccctgcacgcacccccttcctcgcgcctctgccgcccttgccgtttctgtcctcagtgtcctgctggggcttaccccgagtcccgcccaaggtgcagacggcggcggccccgggcctcgctcggtcgcgctcgagccccgtttccagcagcatcgcggcc

SEQ ID NO: 135 - DNA, 230 bp, Homo sapiens
ggggctgcctccctgcgcaccggccgcggtgactcagccccggcccgcccgggcccgcccgcgtcccttgtagttttgggaggtgatcagcgatgagcacggcatcgaccccacgggcacctaccacggggacagcgacctgcagctggaacgcatcaacgtgtactacaatgaggccaccggtgaggccccggccccttccccgaccgccctccggggaccccgcggcc

SEQ ID NO: 136 - DNA, 284 bp, Homo sapiens
cccatgagaggccggggtggagaagccgggggtgaaggggggcaggggccggcgcgccacgcggtccttacctttccgcttggacctccgcctcctcctcctcttggacttgcatttgagttgactgctcagccctccagaccctctgccgctccccaggaccgaggccatggccgagacccaggcgcggagcccagagccgcctccctcctgcacctgcacctgcctccttcccggcagccgccgccgccgctgctgcgaagcttgaggttgcaaacccggga

SEQ ID NO: 137 - DNA, 226 bp, Homo sapiens
ggcatccgtagaacccccgcctttgacctagcttcaggagattactttccgggtcagcgtgcgtttagggcgaagacggagttgtaaacttcttaaaattcctctctcgacacttcggtaattcctctttcgagactaaagctctttttgtatgcgtgtgtgtcaagcgtatgccccgggattctcctccgcttccttttctcggtcttccttcttgctttaggga

SEQ ID NO: 138 - DNA, 197 bp, Homo sapiens
ccagcgcgcccccggccgctcctccgcgccgcgctcgtcggccatggcccgggagaacggcgagagcagctcctcctggaaaaagcaagctgaagacatcaagaagatcttcgagttcaaagagaccctcggaacgtaagtggggaccggggaggcgagggtggaggtggccgcggcaggggctgcacgggcagctc

SEQ ID NO: 139 - DNA, 232 bp, Homo sapiens
ggcctcagcggctgaggagtgcctgtgaggcagaaggcgtctcgcagtccgggttcgatcccagctgcgagccgtcaggcggcaggacctggtctgctgcctgcctgcctcagtttccacgggagtgtgtgtgggtgtgtgtgggtgtgtgagggtgtgtatgggtgttggcctgcgcacaccggagggggggtcggtatacagtcggcgcctaatgcgcgcagcgcctccc

SEQ ID NO: 140 - DNA, 241 bp, Homo sapiens
gctttcagagagcttcggggcctcgccggggtcgctgggcccgggccgccgggccgcctgctgggggcgtaggccgacttgatgtccagagagaaggagggcttgaggcggctggtgtcctgcaggtggtccgaggagaggcgcaggctgcgcaggccctgctgcagcgtgctggtggccgtggggggcgccgggggcttcctgcccgcgctcgggccgccctccctggcagctgcactcc

SEQ ID NO: 141 - DNA, 377 bp, Homo sapiens
caagcccgggcggagcgcgctaagccacaggtccccgcggcgttcctcccggtcttcggggatgctaatggcagcgaaaatatttgctgaagtgcaggcataaatcagccgcctccccgctcccccacccccaccccttttgtttcctcttccttctctccaaaagcgctgggctgctgggcgccagaatttaccttttccatcttagcggcctgattagcatcgccgccgcttgtggggctggattctaccctctcctgcgtcccccacccccagtccccatctccacctccctccccagccgagctaaatcggtctgcggagccccgggagctctaacgccaccgcctagcgagtgagtgcacggagccgccctc

SEQ ID NO: 142 - DNA, 333 bp, Homo sapiens
agccacactgcctggagtaggatgttctcagggcccgggttatttctcccgggttgccccaggagtgtgcagttcccagaaactcatggcaaagtcctctataatctctttccgagcaggggctctgagaagctctgcgcctgtttaagggttgggtgggtttggaggggtgaagaggaaaaagagggagagagactggtggacagttgtcctattctggaattagtattttgccttggaatttcatagctgtaacgttgccgacctcgctgttggcgttgcccgggcttttcaaatatgtagataagactcaagggggcatccaggcctcag

SEQ ID NO: 143 - DNA, 254 bp, Homo sapiens
ttggccctgccctctagctcccgcgctcgctcccgccctcctggctctccgggcgcgcctggcggggcagggcggacatgggcaccaagcagaggagccgcacgcgcacgtactggggctcggatctaccttccagtagcaacggaggagccaatgggaccgcgggcggcggcgggggcgctcgggccaccgcggggcggttcccggctcaggtgcccagtgggcaccagcccagcgcctcgggcggcgctgct

SEQ ID NO: 144 - DNA, 221 bp, Homo sapiens
acggtccggccggggcgcgcggagcctggccccgggcgatccatcctgccgggttttcacggcggccaagggggggcggggctaggtggtctctgagaaccgagcttgactccgacgccgcgaaccgacctggagcccgaggggaaagatgctcgactctcttgggggcaccggagcgggcgcaggagaggcctgcggggtgcgtcccactcacagggatc

SEQ ID NO: 145 - DNA, 299 bp, Homo sapiens
cttgaatttccgccggtacagcgtggaaatgggcaggcaaagcgacttccggctcactccgcttcaagtacccgccgcttcttgctttggtggggagagcaggcaccagagacacgcatgcgcatgtgccagctggcctcaggcgcggcgttcaaagtgtgcggggaggaggtcgagagcggagcatgcgcactggcagacccttgctctttcgctggagactatgcgcaggcgcggtgcactgcgcgccggcacgagggtgttttcgacgttggctgtggggaaacagcaagcggcgt

SEQ ID NO: 146 - DNA, 233 bp, Homo sapiens
gcccgcccgcccgcccgcagcgtcagccctccacttccttcttccagcccggcgcgcccgcccaattcaaacgaaaacgaagattcaaattctggcgctaagcgctgcgattgaacgggaaagcgcggcatgggaccaataggaagggagcgcagggcgtgggcggggagggggcggggaaaccgggctcgcggggcggggctggcgtgtccgcgggcgagccactcacgcat

SEQ ID NO: 147 - DNA, 200 bp, Homo sapiens
ccgaggggagggcagacccgggcagcgccccgcacccccggcggggaaccgggggcatctttcagccacagaaagctggagaagacagaggagctcctgggaagcagggactgagcgacaggaaggggccgagaagcggcgcgggagacccggagagggaaaaggcactggggctgaggcccccggcctggtccgcgacc

SEQ ID NO: 148 - DNA, 285 bp, Homo sapiens
ctagtgaagctcaggggcagtagaatcagacaaaaaggacccctggccccggcctagtggccaggtcctctccttcccagcgcatggagttaagacgctccatatgaagcctagcctgggatatccgtgggtcttacatttgctctcttctgagctgcttcccccacacttccccgctcgctcgaaagactccctatggctgcgtcccagaacttgagtccatccgcccccaggccggggcactgggaggcccatcaccctgtgcaatgtccccgctccaccttg

SEQ ID NO: 149 - DNA, 197 bp, Homo sapiens
cccggggcaccggtgctggggagcctcgggtgcctctgagggcactgcccggctcccacaggggcagcggctcctcgctccgccacacacgttgtccttgggctgttgaggggtgggggagaggtccttgtggggacactgcgaagccggtcccagacatccagcctggcagtgtccagactgcgggggaccggggt

SEQ ID NO: 150 - DNA, 255 bp, Homo sapiens
cggcggcgctggggaacgcaggccccgtgcgggcggctgcgcgcgaagccggctttgcagacgcagcggaaggagccgctggtgttcacgcagcgctcgctcttgcacagcagcccgcgctggttcagctctcggcactcgtcgatatctgaaggtgagggcgacaggtgcggcttcgctgagcctccaggcggctcctcaccaccggccccgcccctgcccccacccccgaagcccggctcacccacgcagcgg

SEQ ID NO: 151 - DNA, 207 bp, Homo sapiens
agcgggtcgccctctcctgccccggagttctccttgacgctcctcagcccgggcgctcgagctcttcctagagtcgctgttgaagaaggcctgccaggtgacccagtcgcggaacgcgaagaccatgaccacatcccacctgtgagcggcgaggagccgggaggggccggcgggtttggcgcggggagttcacacactgaggaaggc

SEQ ID NO: 152 - DNA, 364 bp, Homo sapiens
gagacaggagatggtcattgaagtggtaagaagtgtcccagtatctgtccggctgtccccacctcctcactttgtcctctcttctgctcacaccctctacctgcaggtctccctgctctttcaccccgaggggagccctggtcgagtccccactctgctctgactctctgggaagctggggaagagccctcactctccctgggtctcagtgtccccttgggcactatgggcaggggggtgggcttctggactgtgtccacccagcctgaattctgccttgggctccacagaaggcgatcggtggcaagaaggaccggtctctcttcctgttcacggacctcatcgtctgcaccactctgaagcg

SEQ ID NO: 153 - DNA, 191 bp, Homo sapiens
ggctgggacgggcagggcagggcaggcgccggcggggaggcgcggcggccggagccccgcggggaagtctttccaggtcccgactcggctctctctgcaaaacggggcgaacctcggcgcggcggccgactcccgagctcccggccgcggctccacttcctcctcttcccctgctccctcgccgctcgctc

SEQ ID NO: 154 - DNA, 241 bp, Homo sapiens
tgggggaaaaggggttgtgtcgggtcccttgtcccctcggcggaatccccgggctgcaccttcgctgaccgttagcttcacctctgcagtgggtcatgcagtgctggccatcaatggcatggacgtgaatggcaggtacacggccgacgggaaagaggtgctggagtatctgggtaaccctgctaattacccggtgtccattcgatttggccggccccgcctcacttctaatgagaagctt

SEQ ID NO: 155 - DNA, 271 bp, Homo sapiens
ctggtgcgagaatggggtgctggcccccctccctgggggtggcccggtccggaagcggcgcgcggtggtagttccccgcgttgctgcagctgctgcattgcgccattttccgtcccgcagaatcgggagcttggggcgagagttgtcaaggaggtgccgagcccccacaccagagtcaactcacatttttctgacagagagagtgagggtctgttcctctccggaggctgcggcgagacacccggtgagggacgctgcggctgaagtggac

SEQ ID NO: 156 - DNA, 238 bp, Homo sapiens
ttcggggcgccactggggcggggccccaaacttggggggtggtcgtccccggcggcactctgcaaaactccatttcatccccaactcctctgagaaccctcagaggcgaaccgcgaggtctcaccattcctagactgccagatccaacaatttctccgcggcgacggtagcagccgcagggccaaagccggcttccgtgaggtacgtctacttccggttaacgaaccagggggctggc

SEQ ID NO: 157 - DNA, 243 bp, Homo sapiens
agcgccactgcccctgctcgcctatctgctggcactggcggctcccggccggggcgcggacgagcccgtgtggcggtcggagcaagccatcggagccatcgcggcgagccaggaggacggcgtgtttgtggcgagcggcagctgcctggaccagctggactacagcctggagcacagcctctcgcgcctgtaccgggaccaagcgggcaactgcacagagccggtctcgctggcgccccccgc

SEQ ID NO: 158 - DNA, 243 bp, Homo sapiens
tcgcctcaagagagcggggagggggctcgggggccgcggcctgccctcccggcgggcggctgagggcgagggaggccctcccttctggcgaggggagggagggtgggtcaggagcccccaacccgccctgcggagctcggggccgcgcgaggggcggttgtctgggggagggggcgcggggtgattcagcgcccggcgaggcggaagcggccgcaagaggaggaggggagagcccgtccgcgc

SEQ ID NO: 159 - DNA, 249 bp, Homo sapiens
cgggcaggcggacgccctggggcggcgggcggcggctgccggggctcgccggggctcggccgcccgctgcccatcgataggtattaggaattgatctcgccgctgctctttgttcggttcagtcatcgattagctgccgcgaccatggagaagcgctagtgagccctcggtcggcggagcggccgagcggccaggcggccgggcgaggagcggggaaggcaggggctacggcctcgggcagggggctgc

SEQ ID NO: 160 - DNA, 201 bp, Homo sapiens
agccgctgtcgagtcccagcggaaagaagcccaaggtgccggagaagcccggtcgtggacgttgttgctccctcatcttcgagacccgcacgccctgcggagaggaaatgacaggcacgccgcgaccgtggggcggggctcgcacgagctccgggtttccagaggcaggggccggggccgtagaaggcagagtcgcgcggg

SEQ ID NO: 161 - DNA, 245 bp, Homo sapiens
gggctccaccttctgggtgtgtgggcctcgtagcgtgcggcccattgcccgggcaaccgacgccgtgagcggtgcattgtggtctgcaacaaaatgcaggagaaagatcctgagggaaccatggagtcaatggaccaatggaagaatgccgtgggctgcgtcaagccaatagggtcgcgcggcgaggggcggggccggcgggagcagggcggggcctgagcactaggcggcggcggctggcgtgg

SEQ ID NO: 162 - DNA, 207 bp, Homo sapiens
ggcctggcgtccgtggggcgctgtgcgtctccgagaacgaagcggcctccgggttcgtgtgctccgagcccgagtactgtttgcggccgtcgtcccgtcctggagcaggagtgaggaagcgcctctcactcccccgcgaacccgcagaacaggccgccggcgctatggagaccggcggagcttcccgctccttcaccaaggggccct

SEQ ID NO: 163 - DNA, 223 bp, Homo sapiens
ccccgcgcgccccgcgacctgcttggctgcccgcggctgctgcacaagccggtgacactgccctgcgggatcacggtctgtgagcgctgcgtggagctggggcccgcgcggccacaggcgcgggcgcgggcgcgtgaacgtagtgctgagccgcctgctggagaggttcttcccggccgagtgcccgctgcgcaggctggagggtcaggcgcggagcctgcag

SEQ ID NO: 164 - DNA, 203 bp, Homo sapiens
tggggcccgcccggggggggctcgccgttggcctgcgccctcgcctttccggaggaggcagggagctctgcggcggccgcggcagcagtaaatggcgtcatgtggatccgaggcggaacagagcagttgttgtcccagaggatatatcgcatccggtcccagctcattggctccgcggggctacattcactcacactccagcg

SEQ ID NO: 165 - DNA, 218 bp, Homo sapiens
gccagcctctccccaccacgtcccgggatggtgggcgtcgggtgggagccggcccaggacatccaggtgggatcagccaccgctcaggccctgtcccaagcggacgcggccagaggcagtctcagcaccacgcaggccgcgggttcagtgggcaaagagaggggcccccggtttagaccaaaaacgtgtgttctccaacctcctacttaaaagcccct

SEQ ID NO: 166 - DNA, 219 bp, Homo sapiens
ttccgggtcactgtctggctccacccccccccccccccccactgggttccggaaaggctcagggttgctcccgcgtttcggttcagtgacgtcgtaaattggaatgaggcatccagtttagcaacagcagagatgacgactctgcgattctgagagtccctggcgagcccgggctagcgaaaagtgggggcagaacgaactacatctcccatcgtgcca

SEQ ID NO: 167 - DNA, 251 bp, Homo sapiens
acaacaaataaaacaccctctagcttcccctagactttgtttaactggccgggtctccagaaggaacgctggggatgggatgggtggagagagggagcggctcaaggactttagtgaggagcaggcgagaaggagcacgttcaggcgtcaagaccgatttctccccctgcttcgggagacttttgaacgctcggagaggcccggcatctcaccactttacttggccgtaggggcctccggcacggcaggaa

SEQ ID NO: 168 - DNA, 214 bp, Homo sapiens
gcggcgcgccgccgccccgtaggccccacgcgccgccccgctcctccgccggatcgtctgtgggtgagtctcgagccaggaggctctgagccagtggcgattggctgacgcggtggctgcgcactcggcctgagaaactcggcaagcgcgcagtgtcgactccccggtctatgccaggcgcatctcaggtaaacggttgggcagggaggtttgg

SEQ ID NO: 169 - DNA, 208 bp, Homo sapiens
cggcgggctgcgcagagagctggaagtgcggccggaggcgctgggctgccgggcaggggtggagtccgccccgccgcgccagcagctttcaacgcgcacgaaagtttggggcccgccccctcgggcggtgccgtccccgctgcactcccaccgcgtcccggcccctgccccaggccggagggcagaggaagtgcccggcccctcccga

SEQ ID NO: 170 - DNA, 246 bp, Homo sapiens
tcccgggagcggattgggtctgggagttcccagaggcggctataagaaccgggaactgggcgcggggagctgagttgctggtagtgcccgtggtgcttggttcgaggtggccgttagttgactccgcggagttcatctccctggttttcccgtcctaacgtcgctcgcctttcagtcaggatgtctgcccgtggcccggctatcggcatcgacctgggcaccacctattcgtgcgtcggggtcttc

SEQ ID NO: 171 - DNA, 199 bp, Homo sapiens
cgctggacgccgggcccaggggactgggtggagtctctgggggagtagccggctgtctaaataatgctgcctctctttggtgtgactggttatactttgtcttcttcatacggagtggttccgttttgcgcctaggggcgtaacccgcccgggagggaatctggctgcggcggaccagggggcgcggctcgggatgcct

SEQ ID NO: 172 - DNA, 241 bp, Homo sapiens
cagtaagagaattcaaaacaaaacaaaacaaaacaaaacccagtttccccgggcaggcactgaattccagttttcgcgaactctggccaaaagtttgcagcaagaagtttgcaaactcctgcgcccgatcggcaaaagcggaggggggagttgcaagaggagcaaagtttgaggaaggtgaattaaccaaccggctccatgggctaaggaccgcagtgggcggcagaggccggagcgagcg

SEQ ID NO: 173 - DNA, 205 bp, Homo sapiens
ggatcgccagggcgcccaggctgagaagccccaagccgcgcatcccgcccggctcttccaccacagggagacaggagctgctggcatggggactccgcagtcacctgtgatggctttgagcggcaggttctcagttctcactcctgtgcagccgccgggacatctgaccccggttctgcgacgctggcagcgcgaccgggctcgg

SEQ ID NO: 174 - DNA, 236 bp, Homo sapiens
cgccgagcccctgggccgggcgctgaggcgggcccctctgggcagggcccgggcggggctgggtgggccgcccctgctgctgccgtccatgctgatgtttgcggtgatcgtggcctccagcgggctgctgctcatgatcgagcggggcatcctggccgagatgaagcccctgcccctgcacccgcccggccgcgagggcacagcctggcgcgggaaagcccccaagcctgggggcc

SEQ ID NO: 175 - DNA, 252 bp, Homo sapiens
gggcggccgatccccgaagtccgggcttcaggacccgggccggcagcaccggctgcgagggttgccgaaggcgcacggatctgggcgctgaaaaagccaggatttggcaatggctttgctgtgtggccttgggcaagtcactctgcgtatctgggtttcacttccttcccaatccgaaaacgggattgggttccttgcagcccgggcattcctgaggtctcctttaccccttctcctcccccaagccccggg

SEQ ID NO: 176 - DNA, 227 bp, Homo sapiens
ccagggcccgcagggcccacaccacgtcgggccggccagaccgagcggccggcggactagccccccaaacgcctgagattggggggaccaaattaaaagcagctgtttaacataccttccgagccaggcgaggagtcctgaatgggggggaacgccccccacgggctattggctccccggcgctcacgtcagtcaccctgggcccgcctccgcccttcgccccgcct

SEQ ID NO: 177 - DNA, 261 bp, Homo sapiens
atactacagctttccaagctcctctcggatctcagagtgttggtggggccgggaaggagaagggagagggggggcacccagggaggcaggcgagcgctggggaaagagggtggggaggggttcccccttcccccagcacggtgcgcactagcagcgcccgctgcctttaagaaaagatgcggatggcctgagtgaccgcggtgtggcagaccgggcactcgggctcgctcttctcacagatgcgattggcgcactccatgc

SEQ ID NO: 178 - DNA, 288 bp, Homo sapiens
tccagacctactccacacggccccgagagcaacaaccacccgcaaacaccggcgatgtcactccgcgtagccgctccgcgagccgttgagccccgcaaaatttcaaaccgcgccacggggcgaagcctcgtcgcgattggcgtcgcgtcccgtcgctccaagaaaatccccgcccctcgggctgaagtcgcgggtgcgcaatcggggtggggactcgcgagcagggcctgggaagcgccggagtggcggcgggggatgacgtcactgtctgtgagtggccgggcgtgg

SEQ ID NO: 179 - DNA, 196 bp, Homo sapiens
agacctgtgcgttgcggcttctctgagggtttcgattacggaaaaagtccgggtgacgtacaattaggctgccgcaggctgggaggcttggcggcgtcattccagtttctgcagcgaggtggcgctccaaggtacggcagcgcgcccgggttttcgccaccgagcgcatccgccgccgcgtccacgcagcgaggca

SEQ ID NO: 180 - DNA, 359 bp, Homo sapiens
ccacccgccccctaccctgccactcaccatgttgtggttttgttacctccggctgttacccgcccagtggggtattagttgggccaggaacacctgccctcagtgtgtgccctcagtgtctgccctcctgccctcctcacaggagcccgtgctcttaccctccccctgtgccaggagggcatgacccctcacctcccagcgccctcactcctcgctgagaggggcaagtctacgcaggaaggggatgggcttgccctcccacatctcaggctccagcgggcaagggcacaagaatagtgtagggttggccgggtgcggtggctcacgcctgtaatcccagcactttgggaggccaaggc

SEQ ID NO: 181 - DNA, 208 bp, Homo sapiens
agcagtcggaggacgcggaaggcctgcgagagtcgcccgcgcccagcgccggccttcgggtcccaccttgcgggtgatgttgtgcacgtaggggcacgtgttgcaggagaagcggtggcagcgttgtccctcctccacgatcagcccgttcccgcagccggggcagaacagcagcatggtctcgaactccgcaggctccaactcccgg

SEQ ID NO: 182 - DNA, 379 bp, Homo sapiens
ccggcatctgccttctccttgccagtaaaaaagcaacactgcgggcctccggggatggcagggagctggaacggggacacactgacttctgcaactcagcaagtatcacctctgtcacctccgcctccccgttggattctgcccagcccctgggttctaagattgctgtcccattccacaggcaagccatgagactggggccatgcccagctctgcgtctcccacccctggtggcccagtgagtagtgagttcccagtccctgaggctaccccttccatcgcccacagaggtgaatgccgatactcgcccagctgttcctgacgggccccggggtctctctctgcccctcttccctgcctgccgcactcacagcatcag

SEQ ID NO: 183 - DNA, 191 bp, Homo sapiens
ctcccacggtactgcctttcgcaggctgcacttgggggccctgctcccccggagcccacaccccacgtcgagggccactcacgtatttcaggactgtcttgagccgtgccatgcacaggatggtgacccagatggccgccccggagcccaagaagtcgcagtactgcagcgtgtcgtagctgaggatgcac

SEQ ID NO: 184 - DNA, 215 bp, Homo sapiens
gcgcgcgaggtcaggggaaggcggccttgggcggtcggggcagacgggccggtgaacaggacgcgacctccgcgatcaggggcgcacgtactgctgcacgaactccgcgtaggtgaggtcggcccgacgctccaccgtgcagcgctcctcctccgccacggcccccggcccgcccgggcgcctgcgggcacagctgggtcagcccgcgccccgcc

SEQ ID NO: 185 - DNA, 269 bp, Homo sapiens
gccttccttcaggtccgcagatgcccctccatccggagtgggccttgcccggggttctgttgccgagtccagattcgcagctgtcttttcctctagagtcaggagaatttctggatttgcgggcgccttctcccctgtagaaatggtgacctcaaggcttctaggtcgcatctttcccgagggcaggtacacttcgaagggcctgcactccttctgccccggggcgccccccgccagcccctgcagcctccccgcggagctggcgtttc

SEQ ID NO: 186 - DNA, 201 bp, Homo sapiens
atttattaataaattctagtctctagcttgcaaggaagactacgtttcccggcgtgcagcgtgctggccgtaagcattacgtcctccatcgcgggcgcgcaatgcacctcggggatggtagtgttctggtggcccaacggttttaacagcccgggaatcaaccaccggaagtgccggccctgagaggtggagtcggggtgg

SEQ ID NO: 187 - DNA, 234 bp, Homo sapiens
agaatatgaatggtgccgaacccgccccccgagctcttttccccttgtccggcggctcaactcaccacatgctccgcctccaggtcccgctgcagcttctcgcggaggtattcggcgctgagttccatggcggcagtccagctggaacggcagcccagcagggacacaaccccagctcgggcgccggccacgctaccttgctgccttacaggagccacttccgctggaaaactc

SEQ ID NO: 188 - DNA, 228 bp, Homo sapiens
cccaactcccggccccgcgctcgagcccgctttgtcgcagtgctgcatccgggcactcgcggcgcgcacgcgctctgcgggcccctcccccttcgcggcgcgggtaccccttccccgcctcgtgttggttcagctttctgtcgcgagacccttcgcggaagactcggcggcgcgcgtccggtgtgagccttgtccctcagtggtccttcgcgaatgggcgggatcgct

SEQ ID NO: 189 - DNA, 305 bp, Homo sapiens
cccttgagcccaggctctgctctctgggggggtggggggcgctccaagccggggagccgtgccagccgagtcgtgcgggctgtggcagggaaggggccaccatgggatgtactctgagcgcagaggagagagccgccctcgagcggagcaaggcgattgagaaaaacctcaaagaggatggcatcagcgccgccaaagacgtgaaattactcctgctcggtaaggaccgccgctgctacccccatcccccgaccccggccactccgcaccccctgccaccagctcccccaccccactcgcgcccg

SEQ ID NO: 190 - DNA, 246 bp, Homo sapiens
agggcttactccaaagccagtgggtccccagtcctaagccaagcagtcccgggggaaaacgcttctcatcgccgtgggagcgcggatcttggaagtggctctgggctttcttgggcgaggctctcacagagtagatcggaaatccattctgctggcccgccccacctcggaggacggactaacggacctgagttcccggccctatcttactcttctcagcttctcagcttggctcagctcagagga

SEQ ID NO: 191 - DNA, 245 bp, Homo sapiens
tttatagcactcgtgacgtcaggtccaaatgagaaattgactggcactccgggccaatgggaggcggcgagagcggccgcgattagcataatagtatagaaacaaggaaacttttcggagctgtcaatcagggcccaatcagctgactgtcagctgggacgggctggcttaacccttcctgcgccgctgcctacccgggagggaacgaggcccggcgcaaagtttggtgtaagaggggaaggagt

SEQ ID NO: 192 - DNA, 228 bp, Homo sapiens
cacgaagacagcaatacagatgttacctcggctggtctcagcgcagcaccggcgctgggaaacgacgctgcctgggatggcgggcgcgtgggaaggccccgcggagtgggggtgtgaagtggccgcggggtgtcggcagagacaggcggaagtggcgtcccgatgaggacgaggtgcccgggcagccggggacgggggtgcgaggggcgtgtgcttctcctgttcctg

SEQ ID NO: 193 - DNA, 220 bp, Homo sapiens
gttggagtcggagagctccagcacgggcttggggtgccaggggaactcccggcagtcctcgtcgttcagcacctccacccgcccctgccgcgtgatcacctcgccctgcgggtccagcatgatgagcgtggggatgcctgcagggaagagggggtgcttggccgctggcccgggagatgctggccctgcctggcaggaggctcgcggggtccagcccggg

SEQ ID NO: 194 - DNA, 221 bp, Homo sapiens
cccggccagcgcgccccccggtccccgagcggacggagccgcactcctccggctcctcggacttcctgcctgggcatggctcctccctggggcccacatgggccttcctagggggcctctcaggggaggccgcccgctcgctcagggaggtgaagagcgaatccgcgtccccggtgcccccgatggagtcctttagggtgagccgcttccgatagctcagg

SEQ ID NO: 195 - DNA, 215 bp, Homo sapiens
cttgaaatcctcccttaatgaagtcacaccttctccgtccgcttccacccggtcggcccatggcagagcccccatgtagcccaggaatcggcttggcccttcggggaggtcagcgtccttactgtccccactctccagtgcggcacattcgttcccctaggactccggccggttgccggccccaggcggtgcttctccccaccaccgcccagctc

SEQ ID NO: 196 - DNA, 241 bp, Homo sapiens
ggccttggtcatggtaacgccggctgagcgggccccggctccggggttccggcgggtgaaaggagctgaaatgtcgcttgtcagttcagcggccccccacccaaacgacgacgcctgagccctccgtcgccgccgatgcgagaccgcctccgcccgctggccgcactccgagcctcgcgcctagctcccaccggtgccgcgacgacgaccacttccgtgtccacgtcaccttccgcgacca

SEQ ID NO: 197 - DNA, 208 bp, Homo sapiens
tccgggcccatgaggcgacgaaggaggcgggacggcttttacccagccccggacttccgagacagggaagctgaggacatggcaggagtgtttgacatagacctggaccagccagaggacgcgggctctgaggatgagctggaggagggggtgaggcccggggtccccgggggcccgaggtgacagggccggggcggcggcgcgggct

SEQ ID NO: 198 - DNA, 231 bp, Homo sapiens
ctggggcgggctggggagggggcccagggctggggccggttcggcctcccgggtggcgcgcgggccgaggagctaggaggaccgccgcgccgcttgtcctttggataaaccttggcggttcctcctctggtgtccgtggaccccgccgcggcgttctccagggccgcggacctttgcccaccggttgcgcccgctgccccgggcagaaaggacccccctcctcccggaccg

SEQ ID NO: 199 - DNA, 257 bp, Homo sapiens
ttggctcgcccggcccgcgggctccacctcaggttttcacttttcgctccggagcgagaacgaaacgacaaaaacgcaagaaaacaataaaacgctagaaagcgaagtgaacggcgctgtgcgctctgtgggtcgcgcggggctggggcgctgcacgcgcgcaaggagggacgagaggcggggacaaaaggctgcgcgcccctcgcccggcggcagctgcaccccggggacggcagggcggcacggcggcagggcgg

SEQ ID NO: 200 - DNA, 229 bp, Homo sapiens
ccctagggatgttcttctgccctccggagacgtcggtcttccctggggccggggctcaaggccagggtgccccaagcccaggctccagggtgtgcggggaaaggctcggtcctgctcggcgcggctcgccctgggcactaggggtcgcccctgcccagcggaagccacgcgggcgcgcccggtcgccgcaggtttccccggaccgggaaaagcgaggcgtctccggggc

SEQ ID NO: 201 - DNA, 201 bp, Homo sapiens
acagttctgacagtccaggtggaggacccgcgctctgccgggaaatccccggcttcccgctggggacaaacggtggccgccgcagggagtgctgtgtttgggggtcgggggaggcagggagccccactttccctcgcgctgcctcagtgcccggcctgcgtgcgcgcgccagcctggggtaggaaggtacctctgacattt

SEQ ID NO: 202 - DNA, 202 bp, Homo sapiens
gagccgagccggagtctggctgctcccaccgcccgcacggtgcccacgccgggcgctgcacaagcagaaagacggcactgagttcaagagcatctacagcctggacaagctctaccccgaatctcagggctcggacaccgcctggagggtcccggtgagccgggaaggactggacggaaggggcgttttgtcaggctgctgg

SEQ ID NO: 203 - DNA, 227 bp, Homo sapiens
tgactgtcggggtttggacaagtggctgcgacgacactaaggtggagaccgggatgtagcgaggactcccagagttgggagacgttgtacgcttactgggacctaaatcccgcacgagttcccacccaagtgccgccgccccagcctacgcacgcgcattcgcaccgtctccagccccggggtcctcctgcccctcccgccgtctccgggggccttttctccgctcg

SEQ ID NO: 204 - DNA, 213 bp, Homo sapiens
caccccaggtctcccagcaaaggccgctcctctggccagggtcaattaccggggtgtttcgggcaccaagttcccacactagtgccccattgttacccgtggccccctagtggtcggttgcggacgtggcctctttggttttgttttctcagcgggcggcccccggggcgtgctcccgcggccctgccgcgtgctggtgctgctgaacccgcg

SEQ ID NO: 205 - DNA, 210 bp, Homo sapiens
gctccccaggccccctccgagagcgaggacgcgcccaggcccgctctgccggagccgccactggggggcgtagcgcggacgcgcacccttgcctcgggcgcctgcgcgggaggccgcgtcacgtgacccaccgcggccccgccccgcgacgagctcccgccggtcacgtgacccgcctctgcgcgcccccgggcacgaccccggagtctc

SEQ ID NO: 206 - DNA, 203 bp, Homo sapiens
acccctccgctcccgggagcagagaagctttggtttcatttcccggccccggccgcggtggctgcctgggcgctgagcggggccgcgcgtcccgccagccccccaagctgcgtcgccgcggcttagagaggcccttccctggccaccctcccccgggggtctcggaggggcagccccggagccggctgaaattaaagcctttc

SEQ ID NO: 207 - DNA, 210 bp, Homo sapiens
gactgggctccctcccgggcctcagttgcctcattgctcccgaaacacccggcattccacatccaaatgcacacacacacgcacactcgcggacacaagcacacgcgcgctggcaaagccgcccgcgccgctagtcgcaccgagcgctcgtttctttgtccggatcgggggcgctcccgccgccggggccaacctgcagcggaacaggcg

SEQ ID NO: 208 - DNA, 342 bp, Homo sapiens
aggccccagagctgacaggtccttcccaccaagactccatctccacgcccggctgccctcctccgcccaggactcagagcgggtctctgttggaagcgtgggttcagccccgaggcgcggcaggaaggtgggcacaggctgggctccttccacagcctcagggtcggcctcgtccaagctgttccagggatgcgcgtgggtgaaggccccgcctgctcctcactcccagccgaggtgttcgcctctgcgcgttcccccttctcctgggttcctgcccccgcctttctttccccggagccgtccaccccctcgccgggcgccggctttcaagcctcaaacttg

SEQ ID NO: 209 - DNA, 193 bp, Homo sapiens
ctggacggccgacccttgtgcttttcgggttgaacctgtggacgtgctccgggcgcgctgttagttgccgccccagacctaggaggcgagtcgggtcggctcaggggagcggggtttgggctcggagtctccagtggacctgccggactcgctcctcacccctcaccctttgccgtctcacgcgtggcgtcat

SEQ ID NO: 210 - DNA, 296 bp, Homo sapiens
ccaccgggggctcctccgccggggcatcctgctccggggcatcgttcgccggtcttgtcgctgcggtggaagtgtcgtgttcccagccaggctgggagtggtcgctggcgaggcctggcgtgggcccgcggtgtctgtcagggtgccctgggccagccccgctgattcgatttagagctaacgagagtccaccaacggcaattacaggaacctaatggccttcctgccgcaccgctccgtggcacccggctcgctgtgatgaattgctcattatgtgcagtgttggaatagcctcc

SEQ ID NO: 211 - DNA, 210 bp, Homo sapiens
ctgcaccgggtctttcaagcccatttctcagacttggaaacggcggctccggagagtgaagtcactctctcagggtctctccgtctaaggggcgaaggtgaaactccgagtccacgaggcccagcgtaggtgctccgtaagaagggaagagacttggtcccggatctggctccgatgcctccggccagcccgcccaggcggagccccagt

SEQ ID NO: 212 - DNA, 211 bp, Homo sapiens
cccaggaaaggctttcccggctccctgtcgggggctgacggactcagcccgggcaccaaccctgccaacggctgcaccttcggcgggggcctggccgcggacctgagtttacacagcttcagtgatggtgcttctcttccccacaagggccccgaggcggccggcctgagctccccgctgagcttcccctcgcagcgcggcaaggagggct

SEQ ID NO: 213 - DNA, 195 bp, Homo sapiens
gccacctcctccagcagcggccagttgtcaatctccaggtgcagcagcccgggcagcctgcggaagttctggtcctccagggaggcgatggccaggtggcgcagccgcagggcgcccaggctgcgcagatggcccagcgactccccggacagagccgtgaggttgcagcgctccagggtcagctcctccagggcc

SEQ ID NO: 214 - DNA, 227 bp, Homo sapiens
cccggcgccgcgtcctcctcatcctccaggcgacaaggtcaggaggggccggggcggcgccccttccctcagcccccagcccccagccccctacctgggtcttcccattccatcccgtgggggagggggctggcgaggagggcaagggggagggggcggcaccagggagggcgggaccgggcgggcgggcggggcggggagctccggcagcgcccagccccgccctc

SEQ ID NO: 215 - DNA, 241 bp, Homo sapiens
gtgcgcccatcacgtgcactcagcacacgtcaagtgagcagccgtgatccgggctacagcggggtgccctggaatcccaagggaggccacagagaggagaggagcaggcgatggacatggatgcggaggggctgctgcttcagagaggatgcttgttggggggctcggggctccagctcctcagcgtcacccggggacgcctggcctgagcgctggcggttcccgggagggacacgcagga

SEQ ID NO: 216 - DNA, 348 bp, Homo sapiens
cgcgaccagagagaaaggcagcctgggagggccagcccggccaacccaccgggcctgctgatggccgagcccacgctcgaggggctgaccagagttcaatgcgcctcagaaaactccataaactatcccgtcttatttggcaaaagctcatatttttttcaaagtttgaagacttgaatgaaagagaggaagaggagcctatgggaggaggccgagccccagggcggctgatgcgagtctgtccgcggagactgttggcgctagtctgagtagagcccgagagcagactggtggctcccgggcgccctgaggactcgctgccctttgtagtgttggctgacccccccg

SEQ ID NO: 217 - DNA, 190 bp, Homo sapiens
ggccaggctctgctgtctcgcgagggtccggcctcaatgctccaggccccggcgttgggccgcgcctcctcgtgggcctcggaaggccaggatagccgaggtctccgcgtaggtcccccccagggaaagtgagcggctcccgggccggcccgccttctccccgcccccggcggcccggtttcctccctct

SEQ ID NO: 218 - DNA, 210 bp, Homo sapiens
tcccctgccggaaaatttgggagagaggatcagggaaaccgccaatgcccggaggccaggcctttcacaggaaacagatttcccgcgggtttcgggggcggtggctttttgtgcgaggctgtttctctgcgaatagctcttggagccaaatcttgggacccggaaccgcgtgggcttggcgcatgcgtgttgtaattcaggcgccgaccg

SEQ ID NO: 219 - DNA, 410 bp, Homo sapiens
tgcaagcccggcaggcggcgggcgccgagctcctgtccacggtcagcgccggcccctcctcggtcgtgtccttgcaggagcgcggggggggttgcgaccccaggaaggccctggccgccatccttttcggcgccgtgctgctggcggctgtggccctagccgtgtgcgtggcgaagctgagctgacggacacccgacggccgcctgctgctgccgctccctcccctgagaaaagactcgggatgggtgtggggtctggcctgtgcaaggggagtggtcctaaaaccccgtgtgtgcatgggtacacgcgcgtttccagtgcacatctgcctgggcaggacacggtttcctcttgctggcccgggaggagttaactttgcgccggccgtcagggcattaccgctaacgtct

SEQ ID NO: 220 - DNA, 206 bp, Homo sapiens
tgtagccccgccccgggccttgggctccacctctcggccccacttccgccgggcaagcgtttgtaggcggcgctgccgtaaatcaggcggtctgcttgccgcatcacgcaagatggcggccgcggcggtgaacggggcggcaggcttctcgagctccgggcccgcggcaacctcgggcgctgttctgcaggccgcgaccggcatgt

SEQ ID NO: 221 - DNA, 256 bp, Homo sapiens
tctacttggaggacgtgggcaactgcgagcagctgcggggggcagaggccggctcggtggtggatgagcgcggcttcgtatgggagaaggcggtcgagggcgactttttccgcgtgcagtacagcgaaagcaaccacttgcacgtggacctgtggcccttctacccccgcaatggcgtcatgaccaaggacacgtggctggaccaccggcaggatgtggagtttcccgagcacttcctgcagccgctggtgcccct

SEQ ID NO: 222 - DNA, 195 bp, Homo sapiens
cgtcgggggcctctctggccctacccaggccgtgttctcgatagctttccggaagaaagggatctgggagcgagatgcgtgtagctagcacgatgcgtcgcgcggtgacgctctggcccgacgccgacggcctctcagtggctcccggaggacccggcgggcccagtgttggaggtgaggaggcggggctggcag

SEQ ID NO: 223 - DNA, 212 bp, Homo sapiens
tttgtttagattaagtgttcgcttagcggtgccctcacgcttctgtacccgggatgtggggggcggtacagaccttgaaatccccgcaccgctctctccaccccgagtaaattcatgcgtcccgtcagagtgttaaaatcgccctagggctggttctgtctccggtcgttctgccgtagggctgcgtaggcagctgctttcgcgccgttttc

SEQ ID NO: 224 - DNA, 356 bp, Homo sapiens
gaggtgcggcggtgtgctttttctctagggtttgggttggatggtggcccgggccttccgagtttccatgagtaagctaaagacgttaggaaacagagcagggtggttgaacgggagtgcagcacggttgtgggggcagatactgactatgagagcgttggaggttattctcgcgagatcggatctgggctccgcgaggttttggcgtagttgtgggactgcgcaggcgccgtttggagcccttacgctcacacttctctcccgcgcaggcgcagacggggaagcggagccaacatgccagtggcccggagctgggtttgtcgcaaaacttatgtgaccccgcggagacccttcga

SEQ ID NO: 225 - DNA, 219 bp, Homo sapiens
gcagtctcggtctcccggagctcttgggagcctggccccgcccctttcccggtgattgatgtgtgctgcctctttctgggtgatttacatgtaatgccccgcccctttcgggatgattacgtgtgcctcgacctttaggtgatttacatgtagtgccccgccccgttcccggtgatttacatgtggtgccccgcccctttcctggtgatttacgagtgc

SEQ ID NO: 226 - DNA, 308 bp, Homo sapiens
ggaggggagagggatggcggtgcgcgcgcattcaccgcctccctcccgccgggtctggctttctccctcctgtggccgaagctttcctcggagaaatagaagagggaggccgcgactctatggtgatggacggaggccttacccaatggaaagaggagctgtcccaaggccaggcaatcatatacgactactggagctggcagagcccgccctctttccacttggacctgaataacccgacccaaaccgagtttcgcccggagagactgcgctttcggccaatgagtgcgtcgatttcgagccccagt

SEQ ID NO: 227 - DNA, 261 bp, Homo sapiens
cctgcgcgggtctcggaatgtccaggggtccctactggggatcacaacccggcgaaatgtcgcatttgccaccacctatctcgactgcgtaatcggctttcagccgcagacgctcaggtcctgcagcacccgcggggatccgtgtaggaacctgctgccgctggatggactgagcgattgcttcgcgggtgtcacgcaccagacgccgtgccgggagcgccgggaagggggtacgcgccccaaccccggccgggggagggc

SEQ ID NO: 228 - DNA, 227 bp, Homo sapiens
tctcttcctccggaccttcggccacagagccctcctcatcgttggtgtccggcaggtctaagatgtccttgaccgaaaaccccgtctttgtgttggtcagcgacatggttcgagaccccaaaatttatgtcgcaaagttgtagcttcacttggtcaattcgtggcgctcccctgccccggcgggcgggggaggggggagttggggggagggactgggggaggggagg

SEQ ID NO: 229 - DNA, 200 bp, Homo sapiens
ggcgcggtcactgaaacagggccgatttctcgaaaaccaccccccaccccggtcgctaaagacctccaaaagcgcccctcagcccaaaatggagccaaacctcgagaaagctgagataatacgcgggtccgcaacgccccgtacctgttccggccttcgggcgcctgtggtgctcgtgttcgggaagagattgctgctgc

SEQ ID NO: 230 - DNA, 201 bp, Homo sapiens
tccccgggggcgcagggtgagccagaccccggccgcgcgcgctcgccgccggaggggttaaagtggctgttgtttgatattctctccttttctttttccagatcgaagcggatttccgattgaatggtgagtgtgccccctgcgccgactccggggccccccagccgccggccgcctcccccgcgccctgccggtgccggg

SEQ ID NO: 231 - DNA, 249 bp, Homo sapiens
gcggtgcgccagtgggtaggtctagcagtggcgcagcaatagagcgctccggagcgtctcattggctggatcaaacccaagcgagccattgattggtcgacgcccccagagggttacaattcaaacgcgggcgggcgggcccgcagtcctgcagttgcagtcgtgttctccgagttcctgtctctctgccaacgccgcccggatggcttcccaaaaccgcgacccagccgccactagcgtcgccgccgc

SEQ ID NO: 232 - DNA, 203 bp, Homo sapiens
tgctggcctgggttgtttcgctctgggctgcgcattcatttttagattccggcctcctccctccccgccatctcccgcttctattcttagaaagcaaactggggtgtgcttgggcttcgcagggaagtcagacagaagtttgcccacgtgctccggccgcctgagatatggagttaattaaaaaggaggctttgagcggcagg

SEQ ID NO: 233 - DNA, 220 bp, Homo sapiens
agggcgctaggcaggaccgcggagctcgggcctctggacatggccccgccggccgtcggaagatgaggcagggatgagagacgacctcccgaccccgcgacagctccctccgtgctcagaagccgcagagagtccaccgtatctgcaacctgcgggggacctctcgggcccggtgcgccctacccttggttcgccaccttgctcctcgagtccttgtcca

SEQ ID NO: 234 - DNA, 310 bp, Homo sapiens
cgcactgccgccaggacgcagtgcacctgagggcggagcacccacgccccgggccacctgactcactgtttgtcaactctgctctctgcagccacgccctttcctccttgcctccctccccttttggctcaggggcggcataaccccgcctctctcctgctgtgactggctgtccttgccgtcactccgctgcgtgggcggggctctgagggggcacaggtagaggcccttcgcgaagggattagcatagtcccaccccccggcgcgagcctcgggccgggcgctgattgggcaggcagcggccgacgcg

SEQ ID NO: 235 - DNA, 345 bp, Homo sapiens
cagctgattctgagcggaccgacggaaggagattcgcagagccccttcccggaagtgactgttgtcgcggcaactgccaaaacacagaccaagtcgctgaaggggagggcggacctcccaatcgactggtctggggcccgagatttccactcagggagatacgtgggctgagatgggagttactagatggggaacgggaaatacggcgggaaccacaatcgcgcagttccgcagctgccgccccacaaccgctccacattccagcgtcccttccgccgctttcagtctccacttccggcaacgtttccacgctgtttccggcctgggaaagttcggcggcagcga

SEQ ID NO: 236 - DNA, 192 bp, Homo sapiens
tggcacaaatctgtaggttttcctctgggggtgggcggaggctccaaaccggacggttttctcctggaggactgtgttcagacagatactggtttccttatccgcaggtgtgcgcggcgctcgcaagtggtcagcataacgccgggcgaattcggaaagcccgtgcgtccgtggacgacccacttggaagga

SEQ ID NO: 237 - DNA, 290 bp, Homo sapiens
gggccacgaagacaaaggcgcaaatgccgggtcaggtgggcacagctcccgggagggtgagggggacggcagggacatgggggctgcagctcacagtgaaggtgggggagacagggcgagagggcgttgctggaggtggggtgtgagggacggcttgcgataccctgggactgcggggtagaaagcgcagttctaggggaggtcggggtcagaggtgaagctcgtggggagggcgagacccgggcgcaggtgctcacaggcgagggcggggttcaggttccagctgggct

SEQ ID NO: 238 - DNA, 389 bp, Homo sapiens
agggagcctccagccagaggcaccaggccctagcgggggagaggcagcccgggcagaagtgcctctggctgcaaccaatgagaaggtagccctaaccaagtccactcctggccagtaagaggcggtctttaagcggaaccctcccatctttggccaatgagacgctgtctggtcggagcgctccataactcggccaatggggagggagtcgcccgctaagcgcctgtcaggcctcgaccaacgggatgggcccttcccgccagagcacactgctccaatccaggagcggctgcaggacctgagccaatgagacgcaacctccgctagccgcgcggtgcccggccaataggaggccgcccgtgcccggtagcgtgggaggtgtggggtgg

SEQ ID NO: 239 - DNA, 345 bp, Homo sapiens
ggctgctgaccgtgcccatcctgtctccagcccactcccccaccgcccccggtgccaccgaccaaacagcagtacctatgccagccgctcctggatgccgtcctggccaacatccgctcacctgtcttcaaccattccctgtaccgcacattcgttccagccatgaccgccattcacggcccacccatcacgtatgtccagctgggctgggctttgcggagggcggccagccctgggccgcgtgtgccaggtgtggtcaccatgccgcctccccagggccccagtggtgtgcacccggaagcgcaggcttgaggatgatgagcggcagagcatccccagtgtgct

SEQ ID NO: 240 - DNA, 287 bp, Homo sapiens
gttgggcttacagcgcggccgatccggcgtggacccgggatggctggaccgggcagcacgggggggcagatcggggctgcggccctggcaggcggcgcgcggtccaaggtagccccgagcgtggacttcgaccatagctgctcggacagtgtcgagtacctgacgctcaacttcgggcccttcgaaacagtgcatcgctggcggcgcctcccgccctgcgacgagttcgtgggtgcccggtacggtgggcttcatggggtcctgaggacaggaagggcgatctgcga

SEQ ID NO: 241 - DNA, 290 bp, Homo sapiens
ctccatggcctcctgatccgcagtgtcatctctccctgcagggtggacccggtgcctcacgatgcccccaaacctccaggctacacccgcttcgtctgcgtctctgatacccactcgaggacggaccccatccagatgccgtacggcgacgtgctgatccacgctggggacttcactgagctggggctcccgagcgaggtgaagaagttcaacgagtggctgggtaggtccctcctgccccgggcgggcggctgtgctgagcaggaagggggctcccgccagctcccgag

SEQ ID NO: 242 - DNA, 196 bp, Homo sapiens
cgctcttcgcttgcgcagtcagaacgtcctccgcggccgtgtgaacatccgggtcacaggcgcataaggaccaatgagcgaaggcatcgcgagccagggggcgcggagaaggcggggaatcatggccgcccccagtgttccgcgtccgggggtttgtgggagttgccttgacctgcagctccgccaccgcggaccc

SEQ ID NO: 243 - DNA, 223 bp, Homo sapiens
gcggcaacaaatccttgcagagttgcccgggcccggcccaattgcgccccggcatgccaggcggagcccttggcgggttcctgaggctctccaggaggcccatcaggagctactcctcccaccccgacggccactcaccagacacagacacctccatgagcgcctccagcggccggttgttgtccaggtcgcggctgagctgcagttcgcccgtggcggggtc

SEQ ID NO: 244 - DNA, 295 bp, Homo sapiens
ccgaaacgccacacacccgctgctgcacatcaacacgctgtacgaggcccgggaggaggaggacgggggcccccgcctgccgcaggacgtgggggacctcatcgccatccctgccccacagcagatcctcatcgccaccttcgacgagccgagaacggtcgtgagtactgtggagttttgagggatggcaccgtccaggccgccgagagcccctctgcctgtgtcgtgtggcctggccagcctcccggtggacaccagccctgcgtggacgtggcctgtgcttcgcccgcactgc

SEQ ID NO: 245 - DNA, 229 bp, Homo sapiens
gtgggggaacccagcccagctgaaccaagccgaggccgcggcgccttcccggagcggggccgcgcgactcacgttctcgtggcgcatgtgcttgagcaggcgcagctcgcggtaggcgcgcttggcgaacagctcggactggaaaggccgatacagcttcttgatggccaccttagcgccggtgcggccgtccacggccgagctgcggggcggaccgcttagcgggaag

SEQ ID NO: 246 - DNA, 297 bp, Homo sapiens
tgaaaaacaactcaggccatgacaggaagaggggatctcgggccgtgaccggaagagggagtctcgggccgtgacaggaagagggagtctcgggccgtgacaggaagagggggtctcgggccgtgacaggaagagggggtctcgggccgtgacaggaagagggggtctcgggccgtgacaggaagagggagtctcgggccgtgacaggaagagggggtctcgggccgtgacaggaagagggggtctccggccgtgacaggaagagggggtctcgggccgtgacaggaagaggggatc

SEQ ID NO: 247 - DNA, 359 bp, Homo sapiens
acgacctgtacttgaacgttgccaagtaggtgtgcccgtgggcagaggccgggctgtccctggtgcgggtgccatcggcgtggggtcgtcccccaaccttaccgcttaccgcagcaggcgtcaacagtacgagtgtcttcactacaaaacggatgctcagggaacacgtatcgggtgtcgtttcgatgacatctctcgactctccagcggttctcaaagttcccacatcctggtgcggggcaggagcgcagccttcggtatcccctgcacagataagtttgtcgtcttttcacagattggtgagtagcccgggacactccctcccaccctcagttctgtgataccacggctttagcgcc

SEQ ID NO: 248 - DNA, 448 bp, Homo sapiens
ctcagttgtgggctcctgccgcaaccaagctaacgccaggcccagtagccgggcctcgggcacccgcgccacgtcgggggcacccagtacagccctcagcgatgtagggttgagctccaggagtcccgcggggcccgcgccccgcgccagcagctcctgcaagtggctcacgatgcagcgctcggccgcgtccagcgtgtgagccaggccaaagcgcgctgccacgttggcggcgaagcagcagttctctggagccagctggcgctccaagtagcgcccacagagccccagggcctcagtgacctgcaggtagctggcggcctccagagtgtcctctacagtgtccatggaaagcgacagccaggcagtgtagatgaagtccagcaggcgctgcaggccggctgccgatggcacgtgcaggtggatcacgcgcgcccgggattcctgg

SEQ ID NO: 249 - DNA, 211 bp, Homo sapiens
tcccacctcacggcccgaggcggggcttctttgcgcttaaaagccgagccgggccaatgttcaaatgcgcagctcttagtcgcgggccgactggtgtttatccgtcactcgccgaggttccttgggtcatggtgccagcctgactgagaagaggacgctcccgggagacgaatgaggaaccacctcctcctactgttcaagtacaggggcc

SEQ ID NO: 250 - DNA, 204 bp, Homo sapiens
ccccacctccgtcccaccctccccgactctcctggcccagggcccggcccgggaaggcgttgttttgccagcgggagccgagcgagtgcacagagaaaagcctccctactctaatgagagtgcacacagcgctgcagcgaggaggatgattacccggcgggcggggggcgcgggctcgggccgcgggcggcgtgtgcggcggcc

SEQ ID NO: 251 - DNA, 216 bp, Homo sapiens
ctcggcgagcttgcccatctgccccggcagcagcaggcgcacagccatccgggtctcccaggcagtgatggtctggcgcttggtggagcgggccaggcgaccagcctcggtggcgatgcggtccaatatgtcatgaaccaaagaatccatgacactcacggcctcccgggaaaggctgaggccctggtgaacctgcttcagcacccggcggaaata

SEQ ID NO: 252 - DNA, 206 bp, Homo sapiens
tcccgtgccatgctcggcccaaggagtgggccggccgagcacggggccccggtggccatcacagtcatggtggtgctggtcgcgctggtctggcgggtttggcactgggacttagagccctgggctgcctccagcgccccagtggccacactgatccggatcacggcaggggtgccagctgcacaggcccgacgggcatctcgctg

(19) United States
(12) Patent Application Publication
(10) Pub. No.: US 2012/0004855 A1
(43) Pub. Date: Jan. 5, 2012

(54) METHYLATION BIOMARKERS FOR PREDICTING RELAPSE FREE SURVIVAL

(75) Inventors: Sitharthan Kamalakaran, Pelham, NY (US); Vinay Varadan, New York, NY (US); James B. Hicks, Lattingtown, NY (US)

(73) Assignee: KONINKLIJKE PHILIPS ELECTRONICS N.V., EINDHOVEN (NL)

(21) Appl. No.: 13/141,343

(22) PCT Filed: Dec. 22, 2009
(86) PCT No.: PCT/IB2009/055909

§ 371 Date: Jun. 22, 2011

Related U.S. Application Data
(60) Provisional application No. 61/140,272, filed on Dec. 23, 2008.

(51) Int. Cl. G06F 19/00; C40B 40/06

(52) U.S. Cl. 702/19; 506/16

(57) ABSTRACT

A methylation classification list comprising loci DNA, for which loci the methylation status of the DNA is indicative of likelihood of recurrence of cancer, is provided. Furthermore, a method, apparatus and use for predicting probability of relapse free survival of a subject diagnosed with cancer, are provided.

### FIELD OF THE INVENTION

This invention pertains in general to the field of statistical data processing. More particularly the invention relates to methylation classification correlated to clinical pathological information, for indicating likelihood of recurrence of cancer.

### BACKGROUND OF THE INVENTION

DNA methylation, a type of chemical modification of DNA that can be inherited and subsequently removed without changing the original DNA sequence, is the most well studied epigenetic mechanism of gene regulation. There are areas in DNA where a cytosine nucleotide occurs next to a guanine nucleotide in the linear sequence of bases called CpG islands.

It is known that DNA methylation of these islands, present in the promoter region, can act as a mechanism for gene silencing. Methods exist for experimentally finding the differential methylation, such as differential methylation hybridization, methylation specific sequencing, HELP assay, bisulfite sequencing, CpG island arrays etc.

CpG islands are generally heavily methylated in normal cells. However, during tumorigenesis, hypomethylation occurs at these islands, which may result in the expression of certain repeats. In addition, this hypomethylation correlates to DNA breaks and genome instability. These hypomethylation events also correlate to the severity of some cancers. Under certain circumstances, which may occur in pathologies such as cancer, imprinting, development, tissue specificity, or X chromosome inactivation, gene associated islands may be heavily methylated. Specifically, in cancer, methylation of islands proximal to tumor suppressors is a frequent event, often occurring when the second allele is lost by deletion (Loss of Heterozygosity, LOH). Some tumor suppressors commonly seen with methylated islands are p16, Rassf1a, BRCA1.

There are reported epigenetic markers for colorectal and prostate cancer. For example, Epigenomics AG (Berlin, Germany) has the Septin 9 as a marker for colorectal cancer screening in blood plasma. A method for using methylation sites to predict differential therapy responses in cancer and recommending an appropriate therapy has been disclosed in US20050021240A1. However, the results predicted by this method are limited.

Methods known within the art involves the use of immuno-histopathological variables such as tumor size, ER/PR status, lymph node negativity, etc. to define a clinical prognostic index such as the Nottingham Prognostic Index (NPI). The problem with such an index is that it has been shown to be very conservative, thus typically causing patients to receive aggressive therapy even when a low risk of disease recurrence exists.

An alternate method known within the art involves measurement of the expression levels of a large number of genes, typically around 70, and calculating a risk score based on the relative expression levels of the genes. These prognostic tests are not very specific and also remain very costly in terms of tissue handling requirements. Using RNA is difficult because RNA degrades much faster and needs more careful handling.

Hence, an improved method for obtaining statistically processed methylation data correlated to clinical pathological information would be advantageous and in particular a method allowing for increased flexibility, cost-effectiveness, and/or statistically correct prognosis data would be advantageous.

Accordingly, the present invention preferably seeks to mitigate, alleviate or eliminate one or more of the above-identified deficiencies in the art and disadvantages singly or in any combination and solves at least the above-mentioned problems by providing a method, and a sequence list according to the appended patent claims.

According to an aspect of the invention, a methylation classification list comprising loci DNA, for which loci the methylation status of the DNA is indicative of likelihood of recurrence of cancer, is provided. The methylation classification list comprises at least one sequence of the group comprising SEQ ID NO: 1 to SEQ ID NO: 252.

An advantage of the methylation classification list is that it allows for clinical prognostic tests that could be widely used in clinical practice.

In another aspect, a method for obtaining a methylation classification list comprising statistically processed methylation data correlated to clinical pathological information is provided. The method comprises at least the steps of providing tumour DNA from cancer patients with a known clinical pathological history. Then, the methylation status of the tumour DNA is analyzed, resulting in a methylation classification list. The list comprises a selection of the statistically processed methylation data, wherein the selection is suitable for predicting probability of relapse free survival of a subject. This is advantageous, since DNA methylation may be much more easily measured in the clinical setting compared to data such as gene expression, thus enabling a highly useful clinical prognostic test. A further advantage is that clinicians are able to robustly stratify patients into good or poor prognostic groups and thus make appropriate therapy choices using the discovered DNA methylation markers.

In yet another aspect, a method for predicting probability of relapse free survival of a subject diagnosed with cancer is provided. The method comprises creating a marker panel comprising at least one post from the methylation classification list, providing DNA from the subject, analysing the methylation status of the parts of the DNA from the subject, corresponding to the marker panel. The result is a local methylation classification list, comprising statistically processed methylation data. The local methylation classification list is statistically analysed, which gives a predicted probability of relapse free survival for the subject.

In another aspect, an apparatus for predicting probability of relapse free survival of a subject, who has been diagnosed with cancer, is provided. The apparatus comprises a first unit, creating a marker panel comprising at least one post from the methylation classification list. The apparatus also comprises a second unit, providing DNA from the subject and a third unit, analysing the methylation status of the parts of the DNA from the subject, corresponding to the marker panel. The output is a local methylation classification list comprising statistically processed methylation data. The apparatus further comprises a fourth unit, statistically analysing the local methylation classification list providing a predicted probability of relapse free survival for the subject. The units are operatively connected to each other.

In a further aspect, use of the methylation classification list, for predicting probability of relapse free survival of a subject diagnosed with cancer is disclosed.

Further embodiments of the invention are defined in the dependent claims and in the description of embodiments.

### BRIEF DESCRIPTION OF THE DRAWINGS

These and other aspects, features and advantages of which the invention is capable of will be apparent and elucidated from the following description of embodiments of the present invention, reference being made to the accompanying drawings, in which

FIG. 1 is a schematic overview of a method according to an embodiment;

FIG. 2 is a schematic overview of a method according to another embodiment;

FIG. 3 is a block scheme of an apparatus according to an embodiment; and

FIG. 4 is showing example graphs of Kaplan-Meier curves, used according to an embodiment.

### DESCRIPTION OF EMBODIMENTS

Several embodiments of the present invention will be described in more detail below with reference to the accompanying drawings in order for those skilled in the art to be able to carry out the invention. The invention may, however, be embodied in many different forms and should not be construed as limited to the embodiments set forth herein. Rather, these embodiments are provided so that this disclosure will be thorough and complete, and will fully convey the scope of the invention to those skilled in the art. The embodiments do not limit the invention, but the invention is only limited by the appended patent claims. Furthermore, the terminology used in the detailed description of the particular embodiments illustrated in the accompanying drawings is not intended to be limiting of the invention.

The following description focuses on an embodiment of the present invention applicable to a method for obtaining a methylation classification list comprising statistically processed methylation data correlated to clinical pathological information.

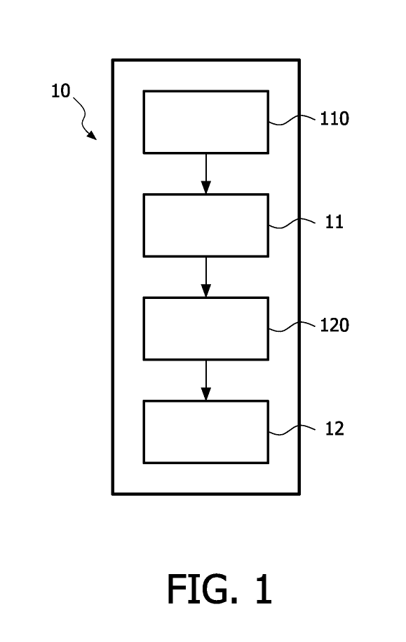

In an embodiment, according to FIG. 1, a method (10) for obtaining a methylation classification list (12) comprising statistically processed methylation data correlated to clinical pathological information is provided. The method comprises creating the methylation classification list (12), based on statistical analysis (120) of DNA (11) provided (110) from tumours of cancer patients with a known clinical pathological history. The tumours may e.g. be 89 tumours, wherein 83 of which have associated clinical pathological records such as relapse incidentals or survival data, for an extended period of time, e.g. 10 years. The method will be described in further detail below.

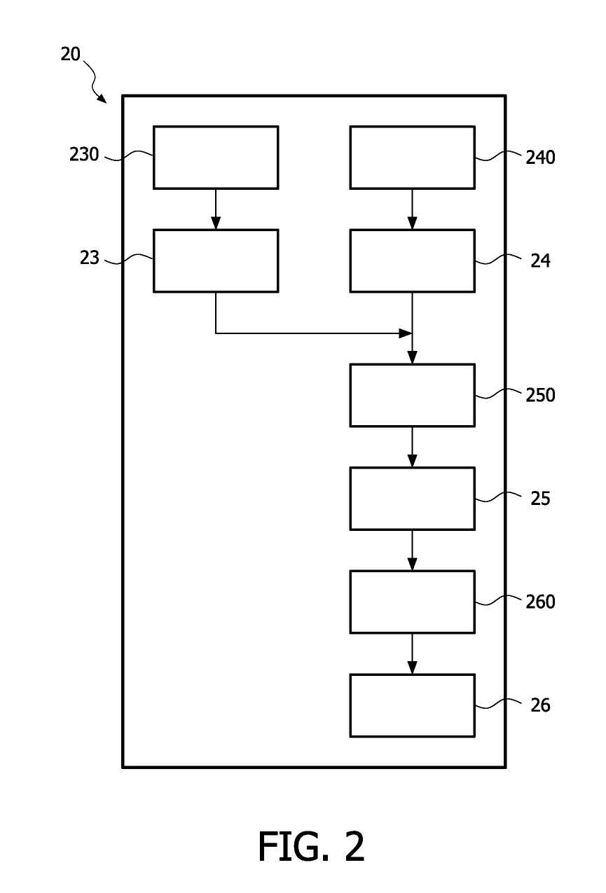

In an embodiment according to FIG. 2, a method (20) for predicting probability of relapse free survival of a subject diagnosed with cancer is provided. The method comprises the following steps. First, a marker panel (23) is created (230). The marker panel (23) comprises at least one post from the methylation classification list (12). Then, DNA (24) is provided (240) from the subject. The methylation status of the parts of the DNA (24) from the subject, corresponding to the marker panel (23) is analyzed (250) resulting in a local methylation classification list (25) comprising statistically processed methylation data. Next, the local methylation classification list (25) is statistically analysed (260), thus giving a predicted probability (26) of relapse free survival for the subject.

Based on the methylation classification list, a marker panel is created by selecting at least one post from the methylation classification list. The selection of loci for the classification is based on the Kaplan-Meier Survivial estimate that is detailed below. In order to select the particular loci for the test from the table, a variety of criteria are used, such as P-value of the difference between methylation status and the likelihood of relapse. Tope performing loci are preferred;

Combination of two loci can be made by accounting for synergy between two loci in making a better prediction of relapse than single loci alone;

Performance and ease of methylation assay will be taken in to account in choosing one loci over the other; and

Other information such as tumor grade or size can be put into the classification scheme, but are not present in the table.

Next, DNA is provided, i.e. by performing extraction from the subject, e.g. from blood, tissue, urine, saliva etc. Extraction is performed according to methods well known to a person skilled in the art, such as ethanol precipitation or by using a DNeasy Blood & Tissue Kit from Qiagen. This results in subject DNA.

Then, the methylation status of each sequence of subject DNA, corresponding to the sequences in the marker panel is analysed using a method well known to the skilled artisan, such as differential methylation hybridization, methylation specific sequencing, HELP assay, bisulphite sequencing, or using a CpG island microarray. The result is a methylation list.

In an embodiment the methylation list is compared to the marker panel and the posts in the methylation list matching posts in the marker panel are selected. The methylation status of the selected posts, i.e. DNA sequences, is checked using a local methylation classification, further described below, thus creating a local methylation classification list. The local methylation classification list is then subject to a diagnostic multivariate analysis, further described below. The result of the multivariate analysis is a predicted probability of relapse free survival for the subject.

### Methylation Classification

In order to find the loci with highest prognosis potential, a methylation classification list is constructed in the following manner. Extraction of DNA is performed according to methods well known to a person skilled in the art, such as ethanol precipitation or by using a DNeasy Blood & Tissue Kit from Qiagen. This results in classification DNA.

The methylation status of each sequence of classification DNA, each locus, is decided using a method well known to the skilled artisan, such as differential methylation hybridization, methylation specific sequencing, HELP assay, bisulphite sequencing, or using a CpG island microarray. The resulting methylation list, based on the classification DNA, is subject to methylation classification.

The methylation classification is performed with the Kaplan-Meier estimator of the survival function, as described below.

Of the 159,436 loci resulting from the 89 tumours, each locus is sorted binary, i.e. associated to a good or a bad prognosis. This is done by first classifying the methylation status of the specific locus as non-methylated, partially methylated or methylated. These three possible states of the locus correspond to three possible groupings of subjects.

The Kaplan-Meier estimator, well known to a person skilled in the art, uses the time to relapse for each patient within the above groupings and calculates the survival probability, S(t), which is, the probability that a patient within the grouping would survive without a relapse for a given length of time. Assuming there were N patients in a specific grouping and the observed time to recurrence for each of the N samples was:

t₁≦t₂≦t₃ . . . ≦t_{N}.

Corresponding to each time tᵢ is nᵢ the number of patients at risk of relapse just prior to tᵢ, and dᵢ, the number of patients who experienced relapse at time tᵢ. The Kaplan-Meier survival function is then defined as:

$$S ( t ) = {Π}_{{t}_{i} \leq t} \frac{{n}_{i} - {d}_{i}}{{n}_{i}}$$

This Kaplan-Meier estimator is used to derive the recurrence-free survival function for each of the three groupings defined by each methylation locus. These survival functions, when plotted against time, give us survival curves. The survival curve has time on the x-axis and probability of recurrence-free survival on the y-axis. Thus, one survival curve is drawn for each grouping generated using the methylation status of a particular locus.

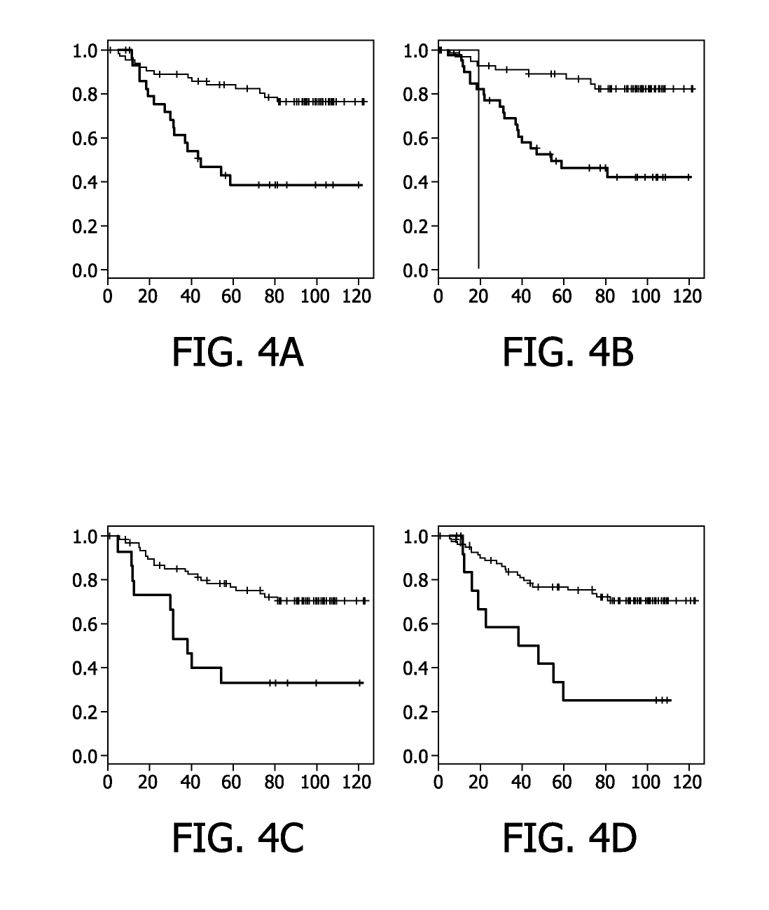

FIG. 4 is showing example graphs of Kaplan-Meier curves. FIG. 4 A is an example of a graph with Topol 144777, FIG. 4B is an example of a graph with JMJD2C 67675, FIG. 4 C is an example of a graph with DLG1 31375 and FIG. 4 D is an example of a graph with Goosecoid 103370. The top curve in each graph represents methylation status 0 and the bottom curve represents methylation status—1. The Kaplan-Meier survival curve has time measured in months on the x-axis and probability of recurrence-free survival on the y-axis. Each patient stratification group is represented by one Kaplan-Meier curve, which captures the rate at which patients in this group tend to relapse. Thus, patient group represented by a curve that falls steeply suggests that patients in this group are at high risk for relapse, whereas patients that are in a group with a relatively flat curve are at lower risk of relapse. Given any two Kaplan-Meier curves, we can interpret differences in the curves at any given time to estimate the difference in risk of relapse for patients in the two groups. Again, the lower the value of a Kaplan-Meier curve at any given time, suggests a higher risk of relapse for patients belonging to the group represented by the curve.

We then check for statistically significant differences between the three Kaplan-Meier survival curves for each locus using the log-rank or Mantel-Haenszel test of the difference in Kaplan-Meier curves. The log-rank test statistic compares estimates of the survival functions of any two groups at each observed event time. It is constructed by computing the observed and expected number of events in one of the groups at each observed event time and then adding these to obtain an overall summary across all time points where there is an event. Let j=1, . . . , J be the distinct times of observed relapse of cancer in any group. For each time, j, let N₁ᵢ and N₂ⱼ be the number of patients at risk of relapse in each group respectively. Let Nⱼ=N₁ⱼ+N₂ⱼ. Let O₁ⱼ and O₂ⱼ be the number of relapses in the groups at time j respectively, and Oⱼ=O₁ⱼ+O₂ⱼ. Given that Oⱼ events happened across both groups at time j, the null hypothesis that the grouping was purely random, would have a hyper geometric distribution with:

mean equal to

$${E}_{j} = {O}_{j} \frac{{N}_{1 j}}{{N}_{j}}$$

and variance

$${V}_{j} = \frac{{O}_{j} ( {N}_{1 j} / {N}_{j} ) ( 1 - {N}_{1 j} / {N}_{j} ) ( {N}_{j} - {O}_{j} )}{{N}_{j} - 1}$$

The logrank statistic then compares each Oⱼ to its expectation under the null hypothesis and is defined as:

$$Z = \frac{{\sum }_{j = 1}^{J} ( {O}_{j} - {E}_{j} )}{\sqrt{{\sum }_{j = 1}^{J} {V}_{j}}}$$

The above Z-value can then be converted into a p-value, which is the probability that the survival functions are different purely by chance, by using the chi-squared statistic:

p=Pr(χ²(1)≧Z)

The p-value as calculated above gives the probability that the observed difference in the two survival curves is purely by chance. It is well known to a person skilled in the art that a p-value of 0.05 or lower is interpreted to suggest that one can be practically certain that the observed difference between the two curves is definitely not due to pure chance. This would suggest that any locus that achieves a p-value (statistical significance) of at least 0.05 or lower, is potentially a good biomarker for stratification of patients into good or poor prognosis groups. We evaluate all 159,436 loci in the above fashion. The loci with a statistical significance of at least 0.05 or lower are stored in a list, shown in table 1, along with their ability to stratify subjects into good or poor prognosis groups. The resulting methylation classification list is provided as SEQ ID NO: 1 to SEQ ID NO: 252. While the p-value is used as a means of including loci in the list, once a particular locus is included, the key elements are the survival curves associated with that locus. These survival curves provide the means to ascertain a patient's risk of relapse at any given point after initial diagnosis, and thus would be used in the embodiment of a diagnostic, as described in the diagnostic multivariate analysis section below.

TABLE 1
Statistically significant list of methylation loci that can individually stratify patients
into good and bad prognosis groups.

| SEQ | | | | | | | |
|---|---|---|---|---|---|---|---|
| ID | | | | | Chi-square | | |
| NO: | Chromosome | Start | End | P-value | value | Gene | Gene Name |
| 1 | chr1 | 1064313 | 1064455 | 0.000386239 | 12.59761578 | AK128271 | Hypothetical protein |
| | | | | | | | FLJ46577. |
| 2 | chr1 | 1741929 | 1742020 | 0.000623577 | 11.70424305 | NADK | NAD kinase |
| 3 | chr1 | 3181325 | 3181447 | 5.19E−08 | 29.64604699 | | |
| 4 | chr1 | 20557064 | 20557187 | 0.000534876 | 11.98997202 | CaMKIINalpha/ | calcium/calmodulin- |
| | | | | | | BC020630 | dependent protein |
| | | | | | | | kinase II/PRO1489 |
| | | | | | | | (CaMKIINalpha |
| | | | | | | | protein). |
| 5 | chr1 | 21855222 | 21855381 | 2.12E−05 | 18.07960521 | CR619608/USP48 | Ubiquitin specific |
| | | | | | | | protease 48./ubiquitin |
| | | | | | | | specific protease 48 |
| 6 | chr1 | 25318507 | 25318605 | 0.000458721 | 12.27640425 | C1orf63 | NPD014 protein |
| | | | | | | | isoform 2 |
| 7 | chr1 | 29625402 | 29625654 | 0.000252817 | 13.3911284 | | |
| 8 | chr1 | 38066662 | 38066799 | 3.63E−06 | 21.45255346 | INPP5B | inositol |
| | | | | | | | polyphosphate-5- |
| | | | | | | | phosphatase, 75 kDa |
| 9 | chr1 | 56756288 | 56756461 | 0.000935047 | 10.95195838 | PPAP2B | phosphatidic acid |
| | | | | | | | phosphatase type 2B |
| 10 | chr1 | 65143624 | 65143729 | 0.000505234 | 12.09624827 | | |
| 11 | chr1 | 92062935 | 92063033 | 0.000853848 | 11.12036797 | TGFBR3 | transforming growth |
| | | | | | | | factor, beta receptor III |
| 12 | chr1 | 93009675 | 93009792 | 0.000371587 | 12.6699137 | AB208980 | MSTP030 (Ribosomal |
| | | | | | | | protein L5). |
| 13 | chr1 | 1.07E+08 | 107395391 | 0.000687924 | 11.52159376 | AB023193/NTNG1 | Splice isoform 2 of |
| | | | | | | | Q9Y2I2/netrin G1 |
| 14 | chr1 | 1.14E+08 | 113645473 | 4.65E−06 | 20.97835927 | MAGI3/MAGI3 | membrane-associated |
| | | | | | | | guanylate kinase- |
| | | | | | | | related 3/membrane- |
| | | | | | | | associated guanylate |
| | | | | | | | kinase-related 3 |
| 15 | chr1 | 1.42E+08 | 142421107 | 0.001050064 | 10.73714195 | PDE4DIP/PDE4DIP | phosphodiesterase 4D |
| | | | | | | | interacting protein |
| | | | | | | | isoform/phosphodiesterase |
| | | | | | | | 4D interacting |
| | | | | | | | protein isoform |
| 16 | chr1 | 1.45E+08 | 145046154 | 0.000902258 | 11.01811403 | FLJ39739 | hypothetical protein |
| | | | | | | | LOC388685 |
| 17 | chr1 | 1.51E+08 | 150762785 | 5.87E−05 | 16.14555739 | JTB | jumping translocation |
| | | | | | | | breakpoint |
| 18 | chr1 | 1.58E+08 | 158230271 | 0.000330063 | 12.89158516 | | |
| 19 | chr1 | 1.58E+08 | 158239282 | 0.00030571 | 16.18574971 | | |
| 20 | chr1 | 1.73E+08 | 172908461 | 0.000248164 | 13.42597512 | RFWD2 | ring finger and WD |
| | | | | | | | repeat domain 2 |
| | | | | | | | isoform a |
| 21 | chr1 | 1.77E+08 | 176855380 | 0.000407058 | 12.49951524 | QSCN6 | quiescin Q6 isoform b |
| 22 | chr1 | 1.77E+08 | 176932542 | 0.000510124 | 12.07828732 | LHX4 | LIM homeobox 4 |
| 23 | chr1 | 1.9E+08 | 189822582 | 0.000566915 | 11.881591 | HRPT2 | parafibromin |
| 24 | chr1 | 2.12E+08 | 211644651 | 0.00090527 | 11.01193681 | KCNK2 | potassium channel, |
| | | | | | | | subfamily K, member 2 |
| 25 | chr1 | 2.2E+08 | 220340980 | 0.000370567 | 12.67505329 | TP53BP2 | tumor protein p53 |
| | | | | | | | binding protein, 2 |
| 26 | chr1 | 2.22E+08 | 222376502 | 0.000513992 | 12.06420764 | KIAA0792 | hypothetical protein |
| | | | | | | | LOC9725 |
| 27 | chr1 | 2.23E+08 | 222616934 | 0.000982028 | 10.86114849 | | |
| 28 | chr1 | 2.23E+08 | 223434254 | 7.21E−05 | 15.75446713 | BC005171 | Chaperone, ABC1 |
| | | | | | | | activity of bc1 complex |
| | | | | | | | like (S. pombe). |
| 29 | chr1 | 2.33E+08 | 233093690 | 0.000722537 | 11.43035956 | MGC72083 | hypothetical protein |
| | | | | | | | LOC440736 |
| 30 | chr1 | 2.42E+08 | 242178360 | 0.001036209 | 10.76172264 | AK001019 | Hypothetical protein |
| | | | | | | | FLJ10157. |
| 31 | chr1 | 2.42E+08 | 242178493 | 0.000406559 | 12.50180374 | AK001019 | Hypothetical protein |
| | | | | | | | FLJ10157. |
| 32 | chr2 | 5781856 | 5781991 | 0.000192958 | 13.89844523 | SOX11 | SRY-box 11 |
| 33 | chr2 | 9298072 | 9298297 | 0.000451361 | 12.30659295 | DDEF2 | development and |
| | | | | | | | differentiation |
| | | | | | | | enhancing factor 2 |
| 34 | chr2 | 10213943 | 10214077 | 0.000147157 | 14.40824202 | RRM2 | ribonucleotide |
| | | | | | | | reductase M2 |
| | | | | | | | polypeptide |
| 35 | chr2 | 16033110 | 16033212 | 0.000631137 | 11.68182256 | MYCNOS/AF320053 | v-myc |
| | | | | | | | myelocytomatosis viral |
| | | | | | | | related oncogene, |
| | | | | | | | neuroblastoma derived |
| | | | | | | | (avian) opposite |
| | | | | | | | strand/N-MYC. |
| 36 | chr2 | 31717290 | 31717412 | 0.000972653 | 10.87891257 | | |
| 37 | chr2 | 32176570 | 32176759 | 0.000620444 | 11.71361603 | LOC84661 | dpy-30-like protein |
| 38 | chr2 | 37370187 | 37370286 | 0.000801102 | 11.23867769 | CEBPZ/PRO1853 | CCAAT/enhancer |
| | | | | | | | binding protein |
| | | | | | | | zeta/hypothetical |
| | | | | | | | protein LOC55471 |
| | | | | | | | isoform 1 |
| 39 | chr2 | 38741040 | 38741184 | 0.000273705 | 13.24227999 | AY236962 | Stromal RNA regulating |
| | | | | | | | factor. |
| 40 | chr2 | 39014423 | 39014605 | 0.001010661 | 10.80793274 | BC060778/MOPT | DHX57 |
| | | | | | | | protein./protein |
| | | | | | | | containing single |
| | | | | | | | MORN motif in testis |
| 41 | chr2 | 46436609 | 46436740 | 1.79E−05 | 18.39971876 | BC051338 | EPAS1 protein. |
| 42 | chr2 | 48756549 | 48756680 | 0.000700308 | 11.48843 | ALF/ALF | TFIIA-alpha/beta-like |
| | | | | | | | factor isoform 1/TFIIA- |
| | | | | | | | alpha/beta-like factor |
| | | | | | | | isoform 1 |
| 43 | chr2 | 73372031 | 73372177 | 3.98E−06 | 21.27457405 | CCT7/C2orf7 | chaperonin containing |
| | | | | | | | TCP1, subunit 7 |
| | | | | | | | isoform |
| | | | | | | | a/chromosome 2 open |
| | | | | | | | reading frame 7 |
| 44 | chr2 | 95253332 | 95253453 | 9.06E−05 | 15.32328453 | CR749650 | Hypothetical protein |
| | | | | | | | DKFZp686D2168. |
| 45 | chr2 | 95614686 | 95614925 | 0.000718539 | 11.4406703 | AK024144 | Hypothetical protein |
| | | | | | | | FLJ14082. |
| 46 | chr2 | 96232849 | 96232973 | 0.000310083 | 13.00848366 | DUSP2/AF331843 | dual specificity |
| | | | | | | | phosphatase |
| | | | | | | | 2/Phosphatase. |
| 47 | chr2 | 99565510 | 99565712 | 0.000443709 | 12.33850961 | REV1L | REV1-like |
| 48 | chr2 | 1.06E+08 | 105820719 | 0.000309255 | 13.01349189 | NCK2 | NCK adaptor protein 2 |
| | | | | | | | isoform A |
| 49 | chr2 | 1.6E+08 | 160297839 | 0.000709552 | 11.46405687 | BAZ2B | bromodomain adjacent |
| | | | | | | | to zinc finger domain, |
| | | | | | | | 2B |
| 50 | chr2 | 1.61E+08 | 161089859 | 0.000241664 | 13.47576785 | RBMS1 | RNA binding motif, |
| | | | | | | | single stranded |
| | | | | | | | interacting protein 1 |
| 51 | chr2 | 2.4E+08 | 240059794 | 0.000602184 | 11.76921502 | BC039904 | HDAC4 protein. |
| 52 | chr3 | 5204530 | 5204673 | 9.03E−05 | 15.32960597 | EDEM1 | ER degradation |
| | | | | | | | enhancer, |
| | | | | | | | mannosidase alpha-like |
| 53 | chr3 | 12680778 | 12680878 | 0.000425083 | 12.41857971 | RAF1 | v-raf-1 murine |
| | | | | | | | leukemia viral |
| | | | | | | | oncogene homolog |
| 54 | chr3 | 14141364 | 14141481 | 0.000933138 | 10.95574521 | BC003125/CHCHD4 | Hypothetical protein |
| | | | | | | | FLJ14560./coiled-coil- |
| | | | | | | | helix-coiled-coil-helix |
| | | | | | | | domain |
| 55 | chr3 | 24511219 | 24511396 | 0.000551997 | 11.93126397 | THRB/THRB | thyroid hormone |
| | | | | | | | receptor, beta/thyroid |
| | | | | | | | hormone receptor, |
| | | | | | | | beta |
| 56 | chr3 | 26639582 | 26639712 | 0.000146625 | 14.41506532 | LRRC3B | leucine rich repeat |
| | | | | | | | containing 3B |
| 57 | chr3 | 33457722 | 33457849 | 0.000344073 | 12.81379493 | UBP1 | upstream binding |
| | | | | | | | protein 1 (LBP-1a) |
| 58 | chr3 | 39423133 | 39423352 | 0.000374847 | 12.65358155 | X15005/X15005 | 40S ribosomal protein |
| | | | | | | | SA (p40) (34/67 kDa |
| | | | | | | | laminin receptor) |
| | | | | | | | (Colon carcinoma |
| | | | | | | | laminin-binding |
| | | | | | | | protein) (NEM/1CHD4) |
| | | | | | | | (Multidrug resistance- |
| | | | | | | | associated protein |
| | | | | | | | MGr1-Ag)./40S |
| | | | | | | | ribosomal protein SA |
| | | | | | | | (p40) (34/67 kDa |
| | | | | | | | laminin receptor) |
| | | | | | | | (Colon carcinoma |
| | | | | | | | laminin-binding |
| | | | | | | | protein) (NEM/1CHD4) |
| | | | | | | | (Multidrug resistance- |
| | | | | | | | associated protein |
| | | | | | | | MGr1-Ag). |
| 59 | chr3 | 46012237 | 46012342 | 0.000236958 | 13.51267433 | FYCO1/FYCO1 | FYVE and coiled-coil |
| | | | | | | | domain containing |
| | | | | | | | 1/FYVE and coiled-coil |
| | | | | | | | domain containing 1 |
| 60 | chr3 | 46593412 | 46593530 | 2.53E−05 | 17.74017338 | TDGF1 | teratocarcinoma- |
| | | | | | | | derived growth factor 1 |
| 61 | chr3 | 48463194 | 48463299 | 4.78E−05 | 16.53330372 | TREX1/TREX1 | three prime repair |
| | | | | | | | exonuclease 1 isoform |
| | | | | | | | d/three prime repair |
| | | | | | | | exonuclease 1 isoform d |
| 62 | chr3 | 49424481 | 49424611 | 0.000167272 | 14.16708091 | RHOA/TCTA/RHOA | ras homolog gene |
| | | | | | | | family, member A/T- |
| | | | | | | | cell leukemia |
| | | | | | | | translocation altered |
| | | | | | | | gene/ras homolog |
| | | | | | | | gene family, member A |
| 63 | chr3 | 49566612 | 49566744 | 0.000674555 | 11.55807856 | BSN | bassoon |
| 64 | chr3 | 57516816 | 57517032 | 0.000620841 | 11.7124272 | 2′-PDE | 2′-phosphodiesterase |
| 65 | chr3 | 61522701 | 61522802 | 0.00097199 | 10.88017587 | BC047734 | PTPRG protein. |
| 66 | chr3 | 1.03E+08 | 102763354 | 0.00013999 | 14.50227829 | BC035967 | FLJ20432 protein (HBV |
| | | | | | | | pre-S2 trans-regulated |
| | | | | | | | protein 2). |
| 67 | chr3 | 1.22E+08 | 121508929 | 0.000982227 | 10.8607719 | | |
| 68 | chr3 | 1.23E+08 | 123195137 | 0.000474985 | 12.2113969 | | |
| 69 | chr3 | 1.24E+08 | 123766114 | 0.00077556 | 11.29882892 | PARP9/BC039580/ | B aggressive lymphoma |
| | | | | | | AY780792 | gene/Splice isoform 2 |
| | | | | | | | of Q8IXQ6/Rhysin 2. |
| 70 | chr3 | 1.24E+08 | 124115294 | 0.000158828 | 14.26455622 | | |
| 71 | chr3 | 1.29E+08 | 128806597 | 0.000650859 | 11.62458127 | | |
| 72 | chr3 | 1.3E+08 | 130362802 | 0.001055342 | 10.72786464 | KIAA1160/KIAA1160 | hypothetical protein |
| | | | | | | | LOC57461/hypothetical |
| | | | | | | | protein LOC57461 |
| 73 | chr3 | 1.43E+08 | 142980179 | 0.000423578 | 12.42520484 | GRK7 | G-protein-coupled |
| | | | | | | | receptor kinase 7 |
| 74 | chr3 | 1.55E+08 | 155322572 | 0.000875873 | 11.07313919 | AB073386 | Hypothetical protein |
| | | | | | | | HMFN1864. |
| 75 | chr3 | 1.99E+08 | 198513786 | 6.60E−05 | 15.9229383 | DLG1/DLG1 | discs, large homolog 1 |
| | | | | | | | (Drosophila)/discs, |
| | | | | | | | large homolog 1 |
| | | | | | | | (Drosophila) |
| 76 | chr4 | 1774869 | 1775089 | 0.000427789 | 12.40672921 | | |
| 77 | chr4 | 1810318 | 1810481 | 0.000662831 | 11.59068096 | | |
| 78 | chr4 | 1.25E+08 | 124676421 | 1.14E−05 | 19.25579282 | SPRY1 | sprouty homolog 1, |
| | | | | | | | antagonist of FGF |
| | | | | | | | signaling |
| 79 | chr4 | 1.47E+08 | 147215955 | 0.000527391 | 12.01623602 | LOC152485 | hypothetical protein |
| | | | | | | | LOC152485 |
| 80 | chr4 | 1.75E+08 | 174629580 | 0.000780177 | 11.28780827 | HMGB2 | high-mobility group |
| | | | | | | | box 2 |
| 81 | chr5 | 271188 | 271302 | 0.000127692 | 14.67554968 | LOC133957/BC041016/ | hypothetical protein |
| | | | | | | LOC133957 | LOC133957/SDHA |
| | | | | | | | protein./hypothetical |
| | | | | | | | protein LOC133957 |
| 82 | chr5 | 1062804 | 1063000 | 2.18E−05 | 18.02734989 | NKD2 | naked cuticle homolog 2 |
| 83 | chr5 | 52320929 | 52321041 | 0.000817865 | 11.20024511 | ITGA2/ITGA2 | integrin alpha 2 |
| | | | | | | | precursor/integrin |
| | | | | | | | alpha 2 precursor |
| 84 | chr5 | 57791657 | 57791770 | 0.000582971 | 11.82958226 | PLK2 | polo-like kinase 2 |
| 85 | chr5 | 60031303 | 60031428 | 0.000759889 | 11.33673246 | BC019075 | Hypothetical protein |
| | | | | | | | FLJ10304 (DEPDC1B |
| | | | | | | | protein). |
| 86 | chr5 | 70256621 | 70256723 | 0.000870432 | 11.08469342 | SMN2 | survival of motor |
| | | | | | | | neuron 2, centromeric |
| | | | | | | | isoform |
| 87 | chr5 | 72287001 | 72287092 | 0.000488126 | 12.16048738 | FCHO2 | FCH domain only 2 |
| 88 | chr5 | 1.3E+08 | 130358943 | 0.000667411 | 11.57787641 | | |
| 89 | chr5 | 1.34E+08 | 134210075 | 0.000335682 | 12.85999469 | FLJ37562 | hypothetical protein |
| | | | | | | | LOC134553 |
| 90 | chr5 | 1.38E+08 | 138117162 | 0.000214628 | 13.69847922 | BC000385/BC000385 | CTNNA1 |
| | | | | | | | protein./CTNNA1 |
| | | | | | | | protein. |
| 91 | chr5 | 1.73E+08 | 172598230 | 0.00075599 | 11.34628548 | NKX2-5 | NK2 transcription |
| | | | | | | | factor related, locus 5 |
| 92 | chr5 | 1.77E+08 | 176876872 | 0.000458614 | 12.27683927 | DDX41 | DEAD-box protein |
| | | | | | | | abstrakt |
| 93 | chr5 | 1.77E+08 | 177344133 | 0.000654362 | 11.61459616 | | |
| 94 | chr6 | 237511 | 237619 | 0.000356749 | 12.74611554 | DUSP22 | dual specificity |
| | | | | | | | phosphatase 22 |
| 95 | chr6 | 31964939 | 31965081 | 0.001020908 | 10.78925848 | | |
| 96 | chr6 | 34311500 | 34311607 | 0.000812493 | 11.21247403 | HMGA1 | high mobility group AT- |
| | | | | | | | hook 1 isoform b |
| 97 | chr6 | 41148102 | 41148203 | 0.000156673 | 14.29026186 | C6orf130/NFYA/ | hypothetical protein |
| | | | | | | C6orf130 | LOC221443/nuclear |
| | | | | | | | transcription factor Y, |
| | | | | | | | alpha isoform |
| | | | | | | | 1/hypothetical protein |
| | | | | | | | LOC221443 |
| 98 | chr6 | 1.29E+08 | 128882815 | 0.0004801 | 12.19141439 | PTPRK | protein tyrosine |
| | | | | | | | phosphatase, receptor |
| | | | | | | | type, K |
| 99 | chr6 | 1.39E+08 | 138525192 | 0.000472925 | 12.21950603 | | |
| 100 | chr6 | 1.46E+08 | 146177821 | 0.000230614 | 13.56360562 | FBXO30 | F-box only protein 30 |
| 101 | chr6 | 1.61E+08 | 161383312 | 0.000572481 | 11.86339358 | AK094629/MAP3K4/ | Hypothetical protein |
| | | | | | | MAP3K4 | FLJ37310./mitogen- |
| | | | | | | | activated protein |
| | | | | | | | kinase kinase kinase |
| | | | | | | | 4/mitogen-activated |
| | | | | | | | protein kinase kinase |
| | | | | | | | kinase 4 |
| 102 | chr7 | 1479500 | 1479665 | 0.0001496 | 14.37724038 | | |
| 103 | chr7 | 4455011 | 4455116 | 2.27E−05 | 17.94884655 | | |
| 104 | chr7 | 5983224 | 5983379 | 0.000814954 | 11.2068621 | | |
| 105 | chr7 | 6466188 | 6466295 | 0.000609951 | 11.74536137 | | |
| 106 | chr7 | 55291210 | 55291340 | 0.001053899 | 10.73039629 | | |
| 107 | chr7 | 72093180 | 72093418 | 0.00088048 | 14.07008724 | | |
| 108 | chr7 | 72171559 | 72171806 | 5.69E−05 | 16.20284108 | NSUN5 | NOL1/NOP2/Sun |
| | | | | | | | domain family, |
| | | | | | | | member 5 isoform 1 |
| 109 | chr7 | 1.02E+08 | 101692023 | 0.000401812 | 12.52374784 | | |
| 110 | chr7 | 1.02E+08 | 101751738 | 0.000611902 | 11.73941723 | RASA4 | RAS p21 protein |
| | | | | | | | activator 4 |
| 111 | chr7 | 1.23E+08 | 122983379 | 0.000325854 | 12.91560316 | WASL | Wiskott-Aldrich |
| | | | | | | | syndrome-like |
| 112 | chr7 | 1.23E+08 | 122983556 | 0.000209449 | 13.74436089 | WASL | Wiskott-Aldrich |
| | | | | | | | syndrome-like |
| 113 | chr7 | 1.29E+08 | 128845655 | 0.000167042 | 14.1696641 | NRF1/NRF1 | nuclear respiratory |
| | | | | | | | factor 1/nuclear |
| | | | | | | | respiratory factor 1 |
| 114 | chr8 | 25958801 | 25958910 | 0.000118967 | 14.80899151 | | |
| 115 | chr8 | 43115669 | 43115790 | 0.000182403 | 14.0041922 | | |
| 116 | chr8 | 86206522 | 86206644 | 0.000957259 | 10.90846366 | BC070092 | Hypothetical protein |
| | | | | | | | FLJ25261. |
| 117 | chr8 | 1.42E+08 | 142388242 | 0.000225669 | 13.60428885 | | |
| 118 | chr8 | 1.45E+08 | 144750913 | 0.000648976 | 11.62997072 | TIGD5/EEF1D | tigger transposable |
| | | | | | | | element derived |
| | | | | | | | 5/eukaryotic |
| | | | | | | | translation elongation |
| | | | | | | | factor 1 delta |
| 119 | chr8 | 1.46E+08 | 145588117 | 0.000813467 | 11.21025169 | BC031570 | ADCK5 protein. |
| 120 | chr9 | 6748739 | 6748894 | 2.40E−05 | 17.84501582 | JMJD2C | jumonji domain |
| | | | | | | | containing 2C |
| 121 | chr9 | 36181413 | 36181517 | 0.000173112 | 14.1025146 | CLTA | clathrin, light |
| | | | | | | | polypeptide A isoform b |
| 122 | chr9 | 42334145 | 42334248 | 0.0001454 | 14.43086267 | | |
| 123 | chr9 | 67245311 | 67245440 | 9.51E−06 | 23.12594975 | | |
| 124 | chr9 | 86993066 | 86993159 | 0.00110196 | 10.64789881 | FLJ45537/FLJ45537 | hypothetical protein |
| | | | | | | | LOC401535/hypothetical |
| | | | | | | | protein LOC401535 |
| 125 | chr9 | 93796287 | 93796379 | 0.000583418 | 11.82815412 | BC064363 | BarH-like homeobox 1. |
| 126 | chr9 | 95348626 | 95348979 | 0.000691745 | 11.51129603 | U43148 | Tumor suppressor |
| | | | | | | | patched short isoform |
| | | | | | | | (Fragment). |
| 127 | chr9 | 1.05E+08 | 104606311 | 0.000599408 | 11.77781574 | NIPSNAP3B | nipsnap homolog 3B |
| 128 | chr9 | 1.07E+08 | 107125545 | 0.000920123 | 10.98177362 | BC020973/BC020973 | RAD23-like protein |
| | | | | | | | B./RAD23-like protein B. |
| 129 | chr9 | 1.07E+08 | 107329991 | 0.001101579 | 10.64853945 | KLF4 | Kruppel-like factor 4 |
| | | | | | | | (gut) |
| 130 | chr9 | 1.11E+08 | 111473181 | 0.000569006 | 11.8747353 | BC040897/BC048318/ | Chromosome 9 open |
| | | | | | | BC040897 | reading frame |
| | | | | | | | 29./BA16L21.2.1./Chromosome |
| | | | | | | | 9 open |
| | | | | | | | reading frame 29. |
| 131 | chr9 | 1.12E+08 | 112329042 | 1.51E−05 | 18.7205768 | KIAA1958 | hypothetical protein |
| | | | | | | | LOC158405 |
| 132 | chr9 | 1.29E+08 | 129018769 | 0.000114139 | 14.88712944 | IER5L/AK123797 | immediate early |
| | | | | | | | response 5- |
| | | | | | | | like/Hypothetical |
| | | | | | | | protein FLJ41803. |
| 133 | chr9 | 1.3E+08 | 129895443 | 0.001090482 | 10.6672655 | BC039728 | Lung seven |
| | | | | | | | transmembrane |
| | | | | | | | receptor 1 (G protein- |
| | | | | | | | coupled receptor 107). |
| 134 | chr9 | 1.36E+08 | 136322760 | 0.000411339 | 12.47996971 | LHX3/LHX3 | LIM homeobox protein |
| | | | | | | | 3 isoform a/LIM |
| | | | | | | | homeobox protein 3 |
| | | | | | | | isoform b |
| 135 | chr9 | 1.37E+08 | 137412116 | 5.34E−07 | 28.88601644 | TUBB2 | tubulin, beta, 2 |
| 136 | chr10 | 1769223 | 1769407 | 0.000323229 | 16.07430111 | AF034837 | Adenosine deaminase, |
| | | | | | | | RNA-specific, B2 (RED2 |
| | | | | | | | homolog rat). |
| 137 | chr10 | 12277961 | 12278087 | 0.000115355 | 14.86713766 | NUDT5/C10orf7/ | nudix-type motif |
| | | | | | | C10orf7 | 5/D123 gene |
| | | | | | | | product/D123 gene |
| | | | | | | | product |
| 138 | chr10 | 12431830 | 12431927 | 0.000105684 | 15.03234547 | CAMK1D | calcium/calmodulin- |
| | | | | | | | dependent protein |
| | | | | | | | kinase ID |
| 139 | chr10 | 39063751 | 39063883 | 0.001081456 | 10.68264099 | | |
| 140 | chr10 | 47793890 | 47794031 | 0.000223518 | 13.62227584 | | |
| 141 | chr10 | 72647384 | 72647661 | 0.000900361 | 11.02201506 | | |
| 142 | chr10 | 76835693 | 76835926 | 9.85E−05 | 15.1649962 | BC007494 | ZNF503 protein. |
| 143 | chr10 | 81731874 | 81732028 | 0.000215209 | 13.69340113 | | |
| 144 | chr10 | 89612230 | 89612351 | 0.000538766 | 11.9764678 | PTEN | phosphatase and |
| | | | | | | | tensin homolog |
| 145 | chr10 | 1.25E+08 | 124703983 | 0.000789103 | 11.26669002 | C10orf88 | hypothetical protein |
| | | | | | | | LOC80007 |
| 146 | chr10 | 1.3E+08 | 129814818 | 0.000202783 | 13.80512059 | MKI67 | antigen identified by |
| | | | | | | | monoclonal antibody |
| | | | | | | | Ki-67 |
| 147 | chr11 | 524896 | 524996 | 0.000450179 | 12.31148697 | HRAS/AK024495 | v-Ha-ras Harvey rat |
| | | | | | | | sarcoma viral |
| | | | | | | | oncogene/Hypothetical |
| | | | | | | | protein |
| | | | | | | | DKFZp761L1518 |
| | | | | | | | (Fragment). |
| 148 | chr11 | 47556581 | 47556766 | 8.41E−06 | 19.84187439 | KBTBD4/NDUFS3 | kelch repeat and BTB |
| | | | | | | | (POZ) domain |
| | | | | | | | containing 4/NADH |
| | | | | | | | dehydrogenase |
| | | | | | | | (ubiquinone) Fe—S |
| | | | | | | | protein 3, |
| 149 | chr11 | 61104518 | 61104615 | 0.000939106 | 10.94393371 | SYT7 | synaptotagmin VII |
| 150 | chr11 | 65063180 | 65063335 | 0.000118217 | 14.8209104 | | |
| 151 | chr11 | 65443997 | 65444104 | 0.000932125 | 10.9577585 | Bles03/DRAP1 | basophilic leukemia |
| | | | | | | | expressed protein |
| | | | | | | | BLES03/DR1-associated |
| | | | | | | | protein 1 |
| 152 | chr11 | 72745477 | 72745741 | 8.93E−05 | 15.35039228 | | |
| 153 | chr11 | 74914419 | 74914510 | 0.000614221 | 11.73237768 | GDPD5 | glycerophosphodiester |
| | | | | | | | phosphodiesterase |
| | | | | | | | domain |
| 154 | chr11 | 1.18E+08 | 118395164 | 0.000238539 | 13.50019151 | RPS25/TRAPPC4 | ribosomal protein |
| | | | | | | | S25/trafficking protein |
| | | | | | | | particle complex 4 |
| 155 | chr12 | 6449822 | 6449993 | 0.000606268 | 11.75663324 | VAMP1 | vesicle-associated |
| | | | | | | | membrane protein 1 |
| | | | | | | | isoform 1 |
| 156 | chr12 | 48248023 | 48248161 | 0.000627616 | 11.6922319 | BC011794/MCRS1 | Hypothetical protein |
| | | | | | | | DKFZp686N07218./microspherule |
| | | | | | | | protein 1 |
| | | | | | | | isoform 2 |
| 157 | chr12 | 93045312 | 93045455 | 0.000614585 | 11.73127392 | PLXNC1 | plexin C1 |
| 158 | chr12 | 1.09E+08 | 109182166 | 0.000840629 | 11.14931181 | ATP2A2/ATP2A2 | ATPase, Ca++ |
| | | | | | | | transporting, cardiac |
| | | | | | | | muscle. slow/ATPase, |
| | | | | | | | Ca++ transporting, |
| | | | | | | | cardiac muscle, slow |
| 159 | chr12 | 1.1E+08 | 109935041 | 0.000588157 | 11.81308979 | CUTL2 | cut-like 2 |
| 160 | chr12 | 1.19E+08 | 119017702 | 0.000682187 | 11.53716216 | RAB35 | RAB35, member RAS |
| | | | | | | | oncogene family |
| 161 | chr12 | 1.19E+08 | 119396577 | 0.000286209 | 13.15855584 | DNCL1 | cytoplasmic dynein |
| | | | | | | | light polypeptide |
| 162 | chr12 | 1.32E+08 | 131949269 | 0.000696339 | 11.49899183 | | |
| 163 | chr13 | 18081618 | 18081741 | 0.000624287 | 11.70212617 | | |
| 164 | chr13 | 79813402 | 79813505 | 0.000929702 | 10.96258238 | SPRY2 | sprouty 2 |
| 165 | chr14 | 18960232 | 18960350 | 0.000554978 | 11.9212304 | | |
| 166 | chr14 | 23771465 | 23771584 | 0.000724239 | 11.4259881 | GMPR2/NEDD8/ | guanosine |
| | | | | | | GMPR2 | monophosphate |
| | | | | | | | reductase 2 isoform |
| | | | | | | | 2/neural precursor cell |
| | | | | | | | expressed, |
| | | | | | | | developmentally/guanosine |
| | | | | | | | monophosphate |
| | | | | | | | reductase 2 isoform 2 |
| 167 | chr14 | 36201449 | 36201600 | 0.000430049 | 12.39689029 | PAX9 | paired box gene 9 |
| 168 | chr14 | 36736922 | 36737036 | 0.000292995 | 13.11465582 | MIPOL1 | mirror-image |
| | | | | | | | polydactyly 1 |
| 169 | chr14 | 50480941 | 50481049 | 0.000827923 | 11.17756613 | PYGL/PYGL | glycogen |
| | | | | | | | phosphorylase, |
| | | | | | | | liver/glycogen |
| | | | | | | | phosphorylase, liver |
| 170 | chr14 | 64077190 | 64077336 | 0.000353102 | 12.76533476 | | |
| 171 | chr14 | 64639425 | 64639524 | 0.000222298 | 13.63254434 | MAX | MAX protein isoform e |
| 172 | chr14 | 94305550 | 94305691 | 0.000176277 | 14.06843945 | GSC | goosecoid |
| 173 | chr15 | 21006802 | 21006907 | 0.000336817 | 12.85367485 | | |
| 174 | chr15 | 38550795 | 38550931 | 0.000414841 | 12.46413445 | D4ST1 | dermatan 4 |
| | | | | | | | sulfotransferase 1 |
| 175 | chr15 | 65904935 | 65905087 | 0.000478806 | 12.19644629 | | |
| 176 | chr15 | 73535116 | 73535243 | 0.001016458 | 10.79734447 | BC066364 | Hypothetical protein. |
| 177 | chr15 | 80122439 | 80122600 | 0.000465946 | 12.24724475 | | |
| 178 | chr15 | 89338732 | 89338920 | 0.000743772 | 11.37654749 | PRC1/PRC1 | protein regulator of |
| | | | | | | | cytokinesis 1 isoform |
| | | | | | | | 2/protein regulator of |
| | | | | | | | cytokinesis 1 isoform 2 |
| 179 | chr15 | 94701203 | 94701299 | 0.001052049 | 10.73364738 | | |
| 180 | chr15 | 99147210 | 99147469 | 0.000402469 | 12.52069456 | LOC440313 | hypothetical protein |
| | | | | | | | LOC440313 |
| 181 | chr16 | 43459 | 43567 | 0.000789488 | 11.26578584 | POLR3K/AF289572/ | DNA directed RNA |
| | | | | | | C16orf33 | polymerase III |
| | | | | | | | polypeptide |
| | | | | | | | K/Hypothetical |
| | | | | | | | protein./U11/U12 |
| | | | | | | | snRNP 25K protein |
| 182 | chr16 | 52214 | 52493 | 0.000185368 | 13.9738827 | | |
| 183 | chr16 | 363973 | 364064 | 0.000349228 | 12.78597469 | MRPL28 | mitochondrial |
| | | | | | | | ribosomal protein L28 |
| 184 | chr16 | 674025 | 674140 | 0.000529605 | 12.00842892 | AF370420/AK124887 | PP14397./Hypothetical |
| | | | | | | | protein FLJ42897. |
| 185 | chr16 | 3244236 | 3244405 | 0.000753382 | 11.35270486 | | |
| 186 | chr16 | 19442583 | 19442684 | 0.000713539 | 11.45364455 | CP110/MIR16 | CP110 |
| | | | | | | | protein/membrane |
| | | | | | | | interacting protein of |
| | | | | | | | RGS16 |
| 187 | chr16 | 29372997 | 29373131 | 0.000128311 | 14.66642755 | BC062756/GIYD2 | Splice isoform 2 of |
| | | | | | | | Q9H3K6/GIY-YIG |
| | | | | | | | domain containing 2 |
| | | | | | | | isoform 1 |
| 188 | chr16 | 31099416 | 31099544 | 0.000264906 | 13.30353853 | FUS | fusion (involved in |
| | | | | | | | t(12; 16) in malignant |
| | | | | | | | liposarcoma) |
| 189 | chr16 | 54783597 | 54783802 | 0.000411643 | 12.47858849 | BC030027/BC030027 | GNAO1 |
| | | | | | | | protein./GNAO1 |
| | | | | | | | protein. |
| 190 | chr16 | 72959992 | 72960138 | 0.000596519 | 11.7868082 | AK124154 | Hypothetical protein |
| | | | | | | | FLJ42160. |
| 191 | chr16 | 78192209 | 78192354 | 0.000914831 | 10.99246447 | MAF | v-maf |
| | | | | | | | musculoaponeurotic |
| | | | | | | | fibrosarcoma |
| | | | | | | | oncogene |
| 192 | chr16 | 86721939 | 86722067 | 0.000787949 | 11.26940745 | | |
| 193 | chr17 | 655150 | 655270 | 6.50E−05 | 15.95085222 | | |
| 194 | chr17 | 24431919 | 24432040 | 6.16E−05 | 16.05151947 | AK124161 | Hypothetical protein |
| | | | | | | | FLJ42167. |
| 195 | chr17 | 38719661 | 38719776 | 0.000375239 | 12.65162484 | MGC20235 | hypothetical protein |
| | | | | | | | LOC113277 |
| 196 | chr17 | 45829715 | 45829856 | 0.000929038 | 10.9639059 | PRO1855/PRO1855 | hypothetical protein |
| | | | | | | | LOC55379/hypothetical |
| | | | | | | | protein LOC55379 |
| 197 | chr17 | 55325368 | 55325476 | 0.000151179 | 14.35746578 | TUBD1/BC053365 | delta-tubulin/RPS6KB1 |
| | | | | | | | protein. |
| 198 | chr17 | 55458830 | 55458961 | 0.000192051 | 13.90730157 | | |
| 199 | chr17 | 56841553 | 56841710 | 0.000433357 | 12.3825826 | LOC388407 | hypothetical protein |
| | | | | | | | LOC388407 |
| 200 | chr17 | 58134948 | 58135077 | 0.000693525 | 11.5065186 | | |
| 201 | chr17 | 63798271 | 63798372 | 0.000426527 | 12.41224765 | SLC16A6 | solute carrier family |
| | | | | | | | 16, member 6 |
| 202 | chr17 | 70520458 | 70520560 | 0.000263538 | 13.31324642 | ICT1 | immature colon |
| | | | | | | | carcinoma transcript 1 |
| 203 | chr17 | 70712975 | 70713102 | 0.001054702 | 10.72898622 | PCNT1 | pericentrin 1 |
| 204 | chr17 | 71893558 | 71893671 | 0.000843093 | 11.14388038 | SPHK1 | sphingosine kinase 1 |
| 205 | chr17 | 75689829 | 75689939 | 4.60E−05 | 16.60634652 | GAA/GAA | acid alpha-glucosidase |
| | | | | | | | preproprotein/acid |
| | | | | | | | alpha-glucosidase |
| | | | | | | | preproprotein |
| 206 | chr17 | 76988422 | 76988525 | 1.29E−06 | 23.43828162 | | |
| 207 | chr17 | 78001554 | 78001664 | 0.000266529 | 13.29208193 | BC003595 | FLJ00406 protein |
| | | | | | | | (Fragment). |
| 208 | chr17 | 78248629 | 78248871 | 0.000399573 | 12.53418719 | RAB40B | RAB40B, member RAS |
| | | | | | | | oncogene family |
| 209 | chr18 | 31964095 | 31964188 | 2.50E−05 | 17.76720291 | BC039498/STATIP1 | SLC39A6 |
| | | | | | | | protein./elongator |
| | | | | | | | protein 2 |
| 210 | chr18 | 75371945 | 75372141 | 0.000239191 | 13.49507221 | | |
| 211 | chr19 | 876428 | 876538 | 0.000609455 | 11.74687509 | ARID3A | AT rich interactive |
| | | | | | | | domain 3A (BRIGHT- |
| | | | | | | | like) |
| 212 | chr19 | 2177443 | 2177554 | 0.000941284 | 10.93964155 | | |
| 213 | chr19 | 2242109 | 2242204 | 0.000471819 | 12.22387338 | AY358234 | EPWW6493. |
| 214 | chr19 | 4149224 | 4149351 | 0.000290339 | 13.13171343 | | |
| 215 | chr19 | 5958898 | 5959039 | 0.000101606 | 15.10662833 | | |
| 216 | chr19 | 6162973 | 6163221 | 7.08E−05 | 15.79054424 | | |
| 217 | chr19 | 13074482 | 13074572 | 0.000820608 | 11.19403341 | LYL1 | lymphoblastic |
| | | | | | | | leukemia derived |
| | | | | | | | sequence 1 |
| 218 | chr19 | 19175104 | 19175214 | 0.000608579 | 11.74955156 | TRA16 | TR4 orphan receptor |
| | | | | | | | associated protein |
| | | | | | | | TRA16 |
| 219 | chr19 | 37859582 | 37859892 | 0.000773148 | 11.30461291 | BC045605/AK127646 | Hypothetical protein |
| | | | | | | | DKFZp434L0718./Hypothetical |
| | | | | | | | protein |
| | | | | | | | FLJ45744. |
| 220 | chr19 | 43557208 | 43557314 | 0.000235626 | 13.52324944 | PSMD8 | proteasome 26S non- |
| | | | | | | | ATPase subunit 8 |
| 221 | chr19 | 51951696 | 51951852 | 0.000899906 | 11.02295246 | | |
| 222 | chr19 | 53814488 | 53814583 | 0.000697731 | 11.49527994 | AB100373/RPL18/ | Sphingosine kinase |
| | | | | | | SPHK2 | 2./ribosomal protein |
| | | | | | | | L18/sphingosine kinase |
| | | | | | | | type 2 isoform |
| 223 | chr19 | 57464757 | 57464869 | 2.28E−05 | 17.9437302 | LOC90321 | hypothetical protein |
| | | | | | | | LOC90321 |
| 224 | chr19 | 59396620 | 59396876 | 0.000198838 | 13.84202995 | RPS9/RPS9 | ribosomal protein |
| | | | | | | | S9/ribosomal protein |
| | | | | | | | S9 |
| 225 | chr19 | 59666829 | 59666948 | 0.00066746 | 11.57774161 | LENG9 | leukocyte receptor |
| | | | | | | | cluster (LRC) member 9 |
| 226 | chr19 | 60542523 | 60542731 | 0.000540702 | 11.96978379 | BC044889 | SUV420H2 protein. |
| 227 | chr20 | 2801205 | 2801366 | 5.60E−05 | 16.23309088 | PTPRA | protein tyrosine |
| | | | | | | | phosphatase, receptor |
| | | | | | | | type, A |
| 228 | chr20 | 21442251 | 21442378 | 0.000258032 | 13.35283597 | NKX2-2 | NK2 transcription |
| | | | | | | | factor related, locus 2 |
| 229 | chr20 | 33793182 | 33793282 | 0.00048638 | 12.16717135 | RNPC2 | RNA-binding region |
| | | | | | | | containing protein 2 |
| | | | | | | | isoform |
| 230 | chr20 | 39091433 | 39091534 | 1.72E−05 | 18.47745076 | TOP1 | DNA topoisomerase I |
| 231 | chr20 | 43874589 | 43874738 | 5.68E−05 | 16.20747328 | UBE2C/UBE2C | ubiquitin-conjugating |
| | | | | | | | enzyme E2C isoform |
| | | | | | | | 4/ubiquitin- |
| | | | | | | | conjugating enzyme |
| | | | | | | | E2C isoform 4 |
| 232 | chr20 | 55757454 | 55757557 | 8.52E−05 | 15.43886697 | | |
| 233 | chr20 | 57948390 | 57948510 | 0.000788526 | 11.26804908 | PPP1R3D/C20orf177 | protein phosphatase 1, |
| | | | | | | | regulatory subunit |
| | | | | | | | 3D/hypothetical |
| | | | | | | | protein LOC63939 |
| 234 | chr20 | 60246637 | 60246847 | 0.000702659 | 11.48220046 | OSBPL2 | oxysterol-binding |
| | | | | | | | protein-like protein 2 |
| | | | | | | | isoform |
| 235 | chr21 | 32906806 | 32907051 | 0.000275888 | 13.22739119 | C21orf59 | hypothetical protein |
| | | | | | | | LOC56683 |
| 236 | chr21 | 46911964 | 46912056 | 0.000586578 | 11.81809635 | | |
| 237 | chr22 | 15863530 | 15863720 | 0.000979733 | 10.86548193 | | |
| 238 | chr22 | 19103828 | 19104117 | 0.001091193 | 10.66606081 | | |
| 239 | chr22 | 19263715 | 19263960 | 0.000260841 | 13.33253083 | | |
| 240 | chr22 | 19661225 | 19661412 | 0.000912645 | 10.99689882 | LZTR1 | leucine-zipper-like |
| | | | | | | | transcription regulator 1 |
| 241 | chr22 | 42155460 | 42155650 | 0.000200341 | 13.82788225 | | |
| 242 | chr22 | 42676139 | 42676235 | 0.000804941 | 11.22980531 | CGI-51/CGI-51 | CGI-51 protein/CGI-51 |
| | | | | | | | protein |
| 243 | chr22 | 45249954 | 45250077 | 0.000385757 | 12.59994853 | | |
| 244 | chr22 | 48920032 | 48920227 | 0.000359446 | 12.73203053 | | |
| 245 | chr22 | 49002030 | 49002159 | 0.000541863 | 11.96578914 | CR456515 | MAPK12 protein. |
| 246 | chrX | 106516 | 106713 | 1.21E−07 | 31.85069213 | | |
| 247 | chrX | 1514977 | 1515236 | 0.000216997 | 13.67786623 | | |
| 248 | chrX | 21434980 | 21435328 | 0.000241991 | 13.47323255 | RP11-450P7.3 | hypothetical protein |
| | | | | | | | LOC257240 |
| 249 | chrX | 23560930 | 23561041 | 0.000635499 | 11.66900762 | SAT/SAT | spermidine/spermine |
| | | | | | | | N1- |
| | | | | | | | acetyltransferase/spermidine/ |
| | | | | | | | spermine N1- |
| | | | | | | | acetyltransferase |
| 250 | chrX | 39721718 | 39721822 | 0.000513949 | 12.06436286 | | |
| 251 | chrX | 1.03E+08 | 103074078 | 0.000803032 | 11.23421147 | H2BFWT | H2B histone family, |
| | | | | | | | member W, testis- |
| | | | | | | | specific |
| 252 | chrX | 1.53E+08 | 152741253 | 0.000292553 | 13.11747938 | | |

The inventors have found that SEQ ID NO's: 135, 78, 230, 82, 120, 60, 75, 63 and 173 are advantageous. The loci of said sequences are surprisingly good biomarkers for stratification of patients into good or poor prognosis groups.

### Local Methylation Classification

From the methylation classification list (12), a local methylation classification list (25) may be obtained according to the following. The methylation status is determined according to any method known in the art. Extraction of DNA is performed according to methods well known to a person skilled in the art, such as ethanol precipitation or by using a DNeasy Blood & Tissue Kit from Qiagen. From the extracted DNA, the methylation status of each sequence of classification DNA, each locus, is decided using a method well known to the skilled artisan, such as differential methylation hybridization, methylation specific sequencing, HELP assay, bisulphite sequencing, The results from these will be the methylation status of each of the assayed loci given in the form of a binary variable—0 or 1.

In an embodiment, Markers 1, 2, 5, 10 are selected from the methylation classification list. Then, DNA from the patient sample is evaluated and the methylation status for each of these loci corresponding to markers 1, 2, 5 and 10 is decided. The results are shown in table 2.

TABLE 2
Methylation status for each of these loci
corresponding to markers 1, 2, 5 and 10.

| MARKER | METHYLATION VALUE |
|---|---|
| Marker 1 | 0 |
| Marker 2 | 1 |
| Marker 5 | 1 |
| Marker 10 | 1 |

The methylation status values are then input into the risk model, detailed in section “Diagnostic Multivariate Analysis” and finally there is an output that gives the probability of relapse risk for the patient based on the measurement of methylation at these loci.

Any kind of markers may be selected from SEQ ID NO: 1 to SEQ ID NO: 252. The methylation status at each of those markers may then be measured and input into the classification model, which will give an output similar to the list shown in table 2.

### Diagnostic Multivariate Analysis

In one embodiment of the invention, the diagnostic assay can include just one of the posts from the list of loci submitted, thus making it a univariate diagnostic assay. In this embodiment, upon diagnosis with breast cancer, a given patient will immediately undergo the diagnostic test as described above and the methylation level of the specific locus will be estimated. Depending on whether the methylation level is unmethylated, partially methylated or methylated, the patient would be placed in the appropriate grouping, thus suggesting that the patient's relapse-free survival function is similar to the one derived for that particular grouping and that specific locus in the list above.

For example, the survival function for locus i in the methylated state is S_{i=Methylated} (t). The risk of relapse for the patient with this methylation status may be estimated from the above survival function as:

R(t)=S_{i=Methylated}(t)

Therefore, if one wishes to give the patient a risk of relapse in 5 years, the above risk function is evaluated at t=5 years.

In another embodiment of the invention, the diagnostic assay could include several loci from the list as independent risk factors. These independent risk factors would be measured as described above and their individual methylation levels ascertained. The risk functions for each of the factors is then be extracted similar to the example described in the previous embodiment. These independent risks can then be combined using any number of approaches, one of which could be as follows.

Let Rᵢ be the probability of relapse in 5 years for a given patient based on the methylation level mⱼ of locus i, in a diagnostic test containing K loci. The total risk of relapse for the given patient may be calculated as:

$$R ( {m}_{1} , {m}_{2} , … {m}_{K} ) = \frac{{R}_{1} {R}_{2} … {R}_{K}}{{R}_{1} {R}_{2} … {R}_{K} + ( 1 - {R}_{1} ) ( 1 - {R}_{2} ) … ( 1 - {R}_{K} )}$$

In another embodiment, the risk assessment from individual loci in the diagnostic assay can be further combined with other risk factors such as age, tumor size, hormone status, etc. The risks from these individual factors can be combined just as above, assuming independence, or depending on further analysis, the factors can be combined in other ways to identify synergies amongst different risk factors, thus including that in the multivariate diagnosis.

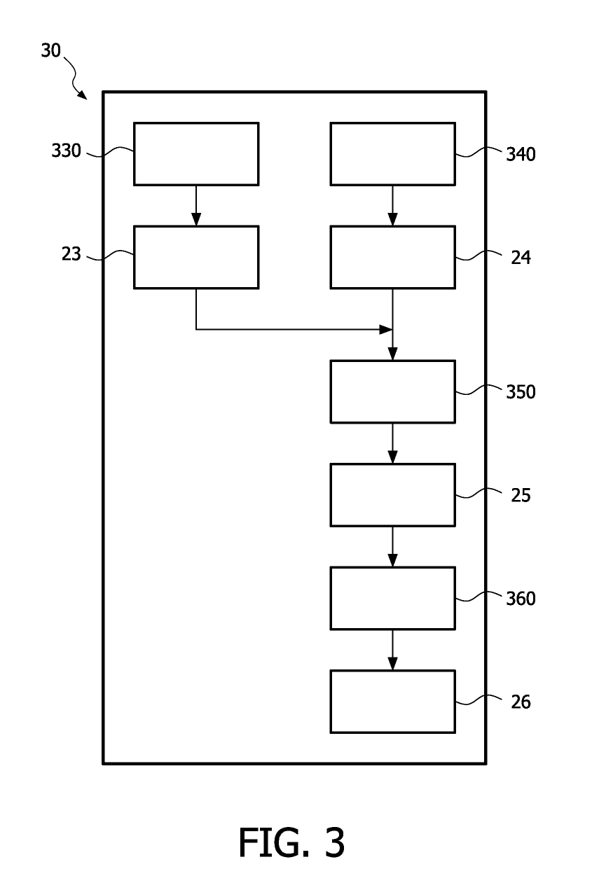

In an embodiment, according to FIG. 3, an apparatus (30) for predicting probability of relapse free survival of a subject, who has been diagnosed with cancer, is provided. The apparatus comprises a first unit (330), creating a marker panel (23) comprising at least one post from the methylation classification list according to any of claims 1 to 3. The apparatus further comprises a second unit (340), providing DNA (24) from the subject and a third unit (350), analyzing the methylation status of the parts of the DNA (24) from the subject, corresponding to the marker panel (23) resulting in a local methylation classification list (25) comprising statistically processed methylation data. The apparatus also comprises a fourth unit (360), statistically analyzing the local methylation classification list (25), thus obtaining a predicted probability (26) of relapse free survival for the subject. The units are operatively connected to each other.

Although the present invention has been described above with reference to specific embodiments, it is not intended to be limited to the specific form set forth herein. Rather, the invention is limited only by the accompanying claims and, other embodiments than the specific above are equally possible within the scope of these appended claims.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. A methylation classification list comprising loci DNA, for which loci the methylation status of the DNA is indicative of likelihood of recurrence of cancer, wherein said methylation classification list comprises at least one sequence of the group comprising SEQ ID NO: 1 to SEQ ID NO: 252.

2. The methylation classification list according to claim 1, comprising the sequences SEQ ID NO: 1 to SEQ ID NO: 252.

3. The methylation classification list according to claim 1, comprising the sequences SEQ ID NOs: 135, 78, 230, 82, 120, 60, 75, 63 and 173.

4. A method (10) for obtaining a methylation classification list (12) according claim 1, comprising statistically processed methylation data correlated to clinical pathological information, said method comprising:
providing (110) tumour DNA (11) from cancer patients with a known clinical pathological history;
analysing (120) the methylation status of the tumour DNA (11), resulting in a methylation classification list (12) comprising a selection of the statistically processed methylation data, wherein said selection is suitable for predicting probability of relapse free survival of a subject.

5. The method (10) according to claim 4, wherein said analysing (120) comprises finding loci with a p-value of 0.05 or lower.

6. A method (20) for predicting probability of relapse free survival of a subject diagnosed with cancer, said method comprising:
creating (230) a marker panel (23) comprising at least one post from the methylation classification list according to claim 1;
providing (240) DNA (24) from the subject;
analysing (250) the methylation status of the parts of the DNA (24) from the subject, corresponding to the marker panel (23) resulting in a local methylation classification list (25) comprising statistically processed methylation data;
statistically analysing (260) the local methylation classification list (25), thus obtaining a predicted probability (26) of relapse free survival for the subject.

7. An apparatus (30) for predicting probability of relapse free survival of a subject, who has been diagnosed with cancer, said apparatus being configured to perform the method according to claim 6, said apparatus comprising
a first unit (330), creating a marker panel (23) comprising at least one post from the methylation classification list;
a second unit (340), providing DNA (24) from the subject;
a third unit (350), analysing the methylation status of the parts of the DNA (24) from the subject, corresponding to the marker panel (23) resulting in a local methylation classification list (25) comprising statistically processed methylation data;
a fourth unit (360), statistically analysing the local methylation classification list (25), thus obtaining a predicted probability (26) of relapse free survival for the subject.

8. Use of the methylation classification list according to claim 1, for predicting probability of relapse free survival of a subject diagnosed with cancer.
